(19) United States
(12) Patent Application Publication
(10) Pub. No.: US 2017/0006304 A1
(43) Pub. Date: Jan. 5, 2017

(54) MOVING IMAGE ENCODER AND MOVING IMAGE ENCODING METHOD

(71) Applicant: FUJITSU LIMITED, Kawasaki-shi (JP)

(72) Inventor: Hidenobu MIYOSHI, Kawasaki (JP)

(73) Assignee: FUJITSU LIMITED, Kawasaki-shi (JP)

(21) Appl. No.: 15/199,026

(22) Filed: Jun. 30, 2016

(30) Foreign Application Priority Data
Jul. 3, 2015 (JP) 2015-134714

(51) Int. Cl. H04N 19/52; H04N 19/117; H04N 19/186; H04N 19/139; H04N 19/159; H04N 19/176; H04N 19/105; H04N 19/119

(52) U.S. Cl. CPC H04N 19/52; H04N 19/105; H04N 19/117; H04N 19/119; H04N 19/139; H04N 19/159; H04N 19/176; H04N 19/186

(57) ABSTRACT

A moving image encoder includes: a filter configured to individually perform filtering on a luminance signal and a chrominance signal; a boundary position calculator configured to calculate a restriction type indicating a position relationship between a reference restriction boundary position and the reference inhibition area before the filtering; a suppression determiner configured to determine whether the filtering on the chrominance signal is suppressed on the basis of the restriction type, and to generate suppression information; an inhibiting mode specifier configured to specify a chrominance filter mode in which a pixel included in the reference inhibition area may be referenced to be an inhibiting mode; and a reference restriction specifier configured to specify a reference restriction position after the filtering on the basis of the reference restriction boundary position before the filtering and the suppression information.

### CROSS-REFERENCE TO RELATED APPLICATION

This application is based upon and claims the benefit of priority of the prior Japanese Patent Application No. 2015-134714, filed on Jul. 3, 2015, the entire contents of which are incorporated herein by reference.

### FIELD

The embodiments discussed herein are related to a moving image encoder.

### BACKGROUND

Data of an image or a video captured by using an imaging device (hereinafter collectively referred to as a “moving image”) is configured of horizontal pixels and vertical pixels. As an example of an image format used to encode such a moving image, a YUV format is known in which a luminance signal (Y) and a chrominance signal (U, V) are separated from each other. In addition, a format is known in which a human visual characteristic is utilized to reduce a resolution of a chrominance signal and to reduce an amount of data. An image format in which only a horizontal resolution of a chrominance signal is reduced to a half is called “4:2:2”. An image format in which each of a horizontal resolution and a vertical resolution is reduced to a half, namely, a resolution as a whole is reduced to a quarter is called “4:2:0”. An image format in which a resolution of a chrominance signal is not reduced is called “4:4:4”.

Data of a moving image generally has a large amount of data. Therefore, for example, when the data of the moving image is transmitted from a transmitter to a receiver, or when the data of the moving image is stored in a storage, high-efficiency encoding is performed. The high-efficiency encoding is encoding for converting a certain data string into another data string, and refers to processing for compressing an amount of the data of the moving image.

As an example of high-efficiency encoding of moving image data, intra-picture prediction (intra-prediction) encoding is known. In this encoding, a characteristic whereby moving image data has a high correlation in a spatial direction is utilized, and an encoded image of another picture is not used. Intra-picture prediction encoding is a method in which an image can be restored by using only information in a picture. As an example of encoding of moving image data, inter-picture prediction (inter-prediction) encoding is known. In this encoding, a characteristic whereby moving image data has a high correlation in a time direction is utilized. Moving image data generally has a high degree of similarity between picture data at a certain timing and picture data at a subsequent timing, and therefore this characteristic is utilized in inter-prediction encoding. In encoding of moving image data, an original image is divided into a plurality of encoded blocks. An encoder references a decoded image of an encoded frame for each of the encoded blocks, selects an area that is similar to each of the encoded blocks, and calculates a difference between the similar area and each of the encoded blocks so as to remove temporal redundancy. By encoding motion vector information indicating the similar area and difference information from which redundancy has been removed, a high compression rate is achieved. Processing for searching for the similar area is generally called “motion estimation”.

Typical examples of moving image encoding as described above include MPEG-2, MPEG-4, H.264/AVC, and H.265/HEVC.

In the moving image encoding above, a reference area from which a motion vector is derived in motion estimation may be restricted. An example of encoding in which a reference area is restricted is intra-refresh that is one example of a technique for achieving a low delay.

In intra-refresh, in each picture, all pieces of data in a slice (an area) are encoded into intra-blocks, and pieces of data in another area are encoded into P-pictures or B-pictures using only a past picture. At this time, by gradually shifting, for each of the pictures, a block line position to which intra-refresh is applied from a block line on a left-hand side of the picture to a block line on a right-hand side of the picture, intra-refresh is circulated in the entirety of the picture in a fixed cycle. When motion estimation is performed, with respect to an area in a leftward direction of a boundary between a refreshed area and a not-yet-refreshed area (a refresh boundary), only a refreshed area of a past encoded picture and a refreshed area that is an encoded area of a current picture are referenced. Accordingly, the entirety of a picture can be refreshed after circulation, and this allows restoration from an error that has occurred due to a transmission error, or decoding of a video stream from the middle. Further, by not using an I-picture having a large amount of information, a buffer can be reduced in size, and a delay due to the buffer can also be reduced.

A technology described in the following document is known.

Document 1: Japanese Examined Patent Application Publication No. 06-101841

### SUMMARY

According to an aspect of the embodiment, a moving image encoder comprising: a motion estimator configured to divide a picture including a luminance signal and a chrominance signal into a plurality of encoded blocks, to reference an encoded picture so as to calculate a motion vector of the luminance signal in each of the plurality of encoded blocks, the encoded picture being provided with a first area in which reference by a subsequent picture is allowed and a second area in which the reference is inhibited, the encoded picture having a reference area of the motion vector of the luminance signal restricted, and to calculate the motion vector of the chrominance signal on the basis of the calculated motion vector of the luminance signal; a filter configured to individually perform filtering on the luminance signal and the chrominance signal in a decoded image of a picture to be encoded; a boundary position calculator configured to calculate a reference restriction type that indicates a combination of a reference restriction boundary position indicating a boundary position between the first area and the second area before the filtering on a current picture to be encoded, and a position relationship between the first area and the second area; a suppression determiner configured to determine whether the filtering on the chrominance signal is suppressed on the basis of the reference restriction type, and to generate chrominance filter suppression information; an inhibiting mode specifier configured to calculate the encoded block in which the filtering on the chrominance signal is suppressed on the basis of the reference restriction boundary position before the filtering, and to specify a chrominance filter inhibiting mode indicating a chrominance filter mode in which a pixel included in the second area may be referenced; a reference restriction specifies configured to specify a reference restriction position of the luminance signal after the filtering on the basis of the reference restriction boundary position before the filtering and the chrominance filter suppression information; and an encoder configured to encode the picture to be encoded by using the motion vector of the luminance signal that has been derived by referencing the first area on the basis of the chrominance filter mode selected from among the chrominance filter modes other than the chrominance filter inhibiting mode, and the reference restriction position of the luminance signal after the filtering.

The object and advantages of the embodiment will be realized and attained by means of the elements and combinations particularly pointed out in the claims.

It is to be understood that both the foregoing general description and the following detailed description are exemplary and explanatory and are not restrictive of the embodiment.

### BRIEF DESCRIPTION OF DRAWINGS

FIG. 1 is a block diagram illustrating an example of a functional configuration of a moving image encoder.

FIG. 2 is a diagram explaining intra-refresh.

FIG. 3 is a diagram explaining reference restriction in intra-refresh.

FIG. 4 is a diagram explaining a filter boundary in DF processing.

FIG. 5 is a diagram explaining a pixel influenced by DF processing.

FIG. 6 is a diagram explaining an offset type in SAO processing.

FIG. 7 is a diagram explaining motion compensation on a luminance signal.

FIG. 8 is a diagram explaining motion compensation on a chrominance signal.

FIG. 9 illustrates a reference restriction boundary when DF processing and SAO processing are enabled.

FIG. 10 illustrates extension of reference restriction due to motion compensation when DF processing and SAO processing are enabled.

FIG. 11 is a diagram explaining whether a prediction image can be generated when DF processing and SAO processing are enabled.

FIG. 12 illustrates a reference restriction boundary when DF processing is disabled and SAO processing is enabled.

FIG. 13 illustrates extension of reference restriction due to motion compensation when DF processing is disabled and SAO processing is enabled.

FIG. 14 is a diagram explaining whether a prediction image can be generated when DF processing is disabled and SAO processing is enabled.

FIG. 15 illustrates reference restriction in a vertical direction of a screen in the 4:2:2 format.

FIG. 16 is a block diagram illustrating a functional configuration of a moving image encoder according to an embodiment.

FIG. 17 illustrates a position of a reference restriction boundary before SAO processing when DF processing is enabled.

FIG. 18 illustrates a position of a reference restriction boundary before SAO processing when DF processing is disabled.

FIG. 19 illustrates a relationship between a reference restriction type and a chrominance filter inhibiting mode.

FIG. 20 illustrates a position of a reference restriction boundary after SAO processing when DF processing is enabled according to the embodiment.

FIG. 21 illustrates a position of a reference restriction boundary after SAO processing when DF processing is disabled according to the embodiment.

FIG. 22 is a diagram explaining whether a prediction image can be generated when DF processing and SAO processing are enabled according to the embodiments.

FIG. 23 is a diagram explaining whether a prediction image can be generated when DF processing is disabled and SAO processing is enabled according to the embodiments.

FIG. 24 is a flowchart illustrating a procedure of a reference restriction controlling process in moving image encoding according to the embodiments.

FIG. 25 is a flowchart illustrating the content of a pre-SAO boundary position setting process.

FIG. 26 is a flowchart illustrating the content of a reference restriction type setting process.

FIG. 27 is a flowchart illustrating the content of a chrominance filter suppression determining process.

FIG. 28 is a flowchart illustrating the content of a chrominance filter inhibiting mode specifying process.

FIG. 29 illustrates a hardware configuration of a computer.

FIG. 30 is a diagram explaining moving image encoding performed by setting a ROI.

### DESCRIPTION OF EMBODIMENTS

Preferred embodiments of the present invention will be explained with reference to accompanying drawings.

In moving image encoding, an image that is decoded on the basis of a signal obtained by performing inverse quantization and inverse orthogonal transformation on a signal on which orthogonal transformation and quantization have been performed and a prediction image is used as a reference picture when deriving a motion vector from a subsequent picture. At this time, in order to reduce block distortion in the decoded image, a process of applying a filter called a deblocking filter is performed. Further, in H.265/HEVC, which is the latest moving image encoding, after the deblocking filter is applied, filtering called Sample Adaptive Offset (SAO) is performed. By performing SAO processing, as an example, ringing due to a motion compensation interpolation filter can be reduced, or deviation of a pixel value that may occur in a decoded image can be corrected, and this allows image quality to be improved. Hereinafter, a process of applying the deblocking filter and a process of performing SAO are referred to as DF processing and SAO processing, respectively.

However, when the SAO processing is performed in encoding in which a reference area is restricted when calculating a motion vector, such as intra-refresh, a boundary between a referable area and a reference inhibition area (a reference restriction boundary) is shifted on the side of the referable area, and the referable area is narrowed. Further, when a moving image in the 4:2:0 or 4:2:2 format is encoded in encoding in which a reference area is restricted, an area that is inhibited from being referenced is generated on the side of the referable area of the reference restriction boundary due to motion compensation. When the area that is inhibited from being referenced is generated within the referable area, a prediction image according to an image format may fail to be generated even within the referable area, and a motion vector may fail to be calculated. When the motion vector fails to be calculated within the referable area, there is a possibility that optimum motion compensation fails to be performed. Namely, in conventional moving image encoding for performing the SAO processing, an optimum prediction image may fail to be generated, and image quality may deteriorate remarkably.

A configuration of a moving image encoder and encoding for encoding a moving image according to the H.265/HEVC standard are described below.

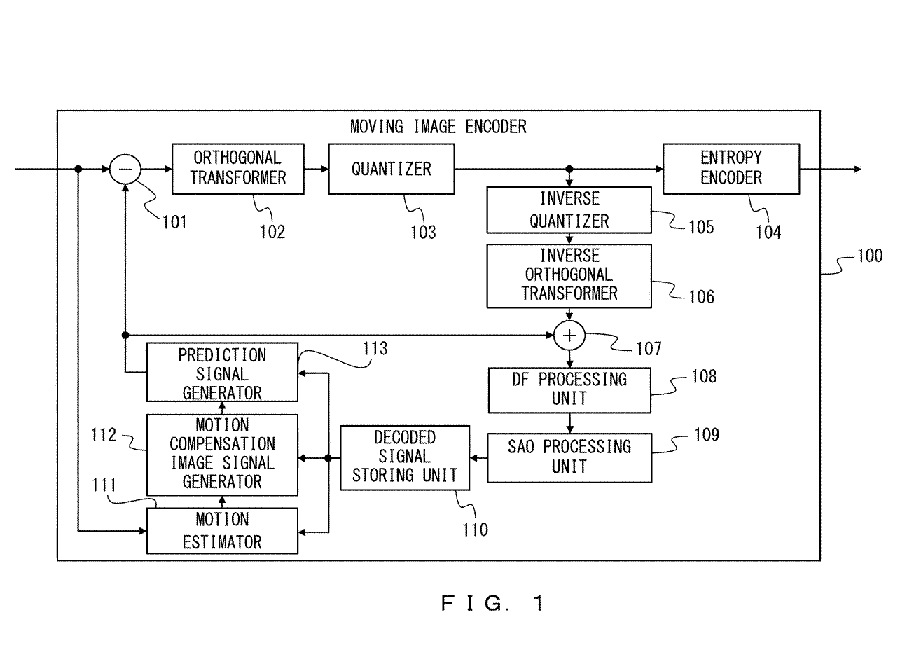

FIG. 1 is a block diagram illustrating an example of a functional configuration of a moving image encoder.

As illustrated in FIG. 1, a moving image encoder 100 includes a prediction error signal generator 101, an orthogonal transformer 102, a quantizer 103, an entropy encoder 104, an inverse quantizer 105, an inverse orthogonal transformer 106, and a decoded image generator 107. The moving image encoder 100 also includes a DF processing unit 108, an SAO processing unit 109, a decoded image storing unit 110, a motion estimator 111, a motion compensation image signal generator 112, and a prediction signal generator 113.

The prediction error signal generator 101 generates a prediction error signal on the basis of an encoded block in an image (a picture) to be encoded of input moving image data and a prediction image output from the prediction signal generator 113. The prediction error signal is a signal indicating a difference between the encoded block and the prediction image. The prediction error signal generator 101 outputs the generated prediction error signal to the orthogonal transformer 102.

The orthogonal transformer 102 performs known orthogonal transformation such as discrete cosine transformation so as to transform the input prediction error signal (a signal of a time domain) into a signal of a frequency domain in which frequency components in a horizontal direction and a vertical direction have been separated from each other. The orthogonal transformer 102 outputs the transformed signal of the frequency domain to the quantizer 103.

The quantizer 103 quantizes the input signal of the frequency domain so as to reduce the amount of information.

The quantizer 103 outputs a quantization result to the entropy encoder 104 and the inverse quantizer 105.

The entropy encoder 104 performs entropy encoding (variable-length encoding) on the input quantization result, and outputs a result as a bit stream. The entropy encoding refers to a scheme for allocating a variable-length code in accordance with the appearance frequency of a symbol.

The inverse quantizer 105 performs inverse quantization on the input quantization result, and outputs an inverse quantization result to the inverse orthogonal transformer 106. The inverse orthogonal transformer 106 performs inverse orthogonal transformation so as to transform the inverse quantization result (a signal of a frequency domain) into a signal of a time domain, and outputs the signal of the time domain to the decoded image generator 107. The inverse quantizer 105 and the inverse orthogonal transformer 106 perform decoding so as to obtain a signal that corresponds to a prediction error signal before encoding (quantization).

The decoded image generator 107 adds block data of the prediction image output from the prediction signal generator 113 and the signal output from the inverse orthogonal transformer 106 so as to generate a decoded image that recovers block data of a block to be encoded. The decoded image generator 107 outputs the generated decoded image to the DF processing unit 108.

The DF processing unit 108 performs, on the input decoded image, DF processing for applying a deblocking filter for reducing block distortion, and outputs an image after the DF processing to the SAO processing unit 109.

The SAO processing unit 109 performs, on the input image after the DF processing, SAO processing for adding or subtracting an offset to/from a pixel value in accordance with a prescribed method, and stores an image after the SAO processing as a decoded signal (recovered block data) in the decoded signal storing unit 110.

The decoded signal storing unit 110 stores the input recovered block data as new block data of a reference picture. The block data of the reference picture is referenced by the motion estimator 111, the motion compensation image signal generator 112, and the prediction signal generator 113.

The motion estimator 111 determines an area that is similar to the block to be encoded in the block data of the reference picture in accordance with a block matching technique, and derives a motion vector indicating the area. The motion estimator 111 references the reference picture, derives a motion vector of a luminance signal of the block to be encoded, and derives a motion vector of a chrominance signal from the derived motion vector of the luminance signal. The motion estimator 111 outputs the derived motion vector to the motion compensation image signal generator 112. Hereinafter, the motion vector of the luminance signal and the motion vector of the chrominance signal are also referred to as a “luminance vector” and a “chrominance vector”, respectively.

The motion compensation image signal generator 112 performs prescribed motion compensation according to the input motion vector so as to generate a prediction image of inter-prediction. The motion compensation image signal generator 112 outputs the generated prediction image of inter-prediction to the prediction signal generator 113.

The prediction signal generator 113 generates a prediction signal of inter-prediction or intra-prediction. The prediction signal generator 113 outputs the generated prediction signal to the prediction error signal generator 101 and the decoded image generator 107.

In the moving image encoder 100, when the motion estimator 111 references a reference picture and derives a motion vector, a reference area may be restricted. The reference area is restricted, for example, in encoding called intra-refresh for achieving low-delay encoding.

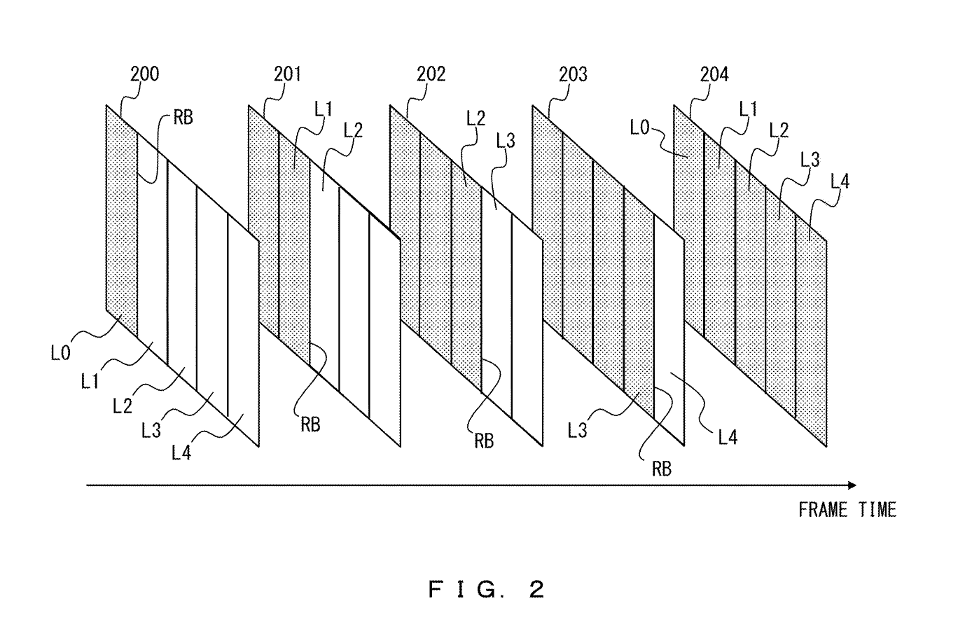

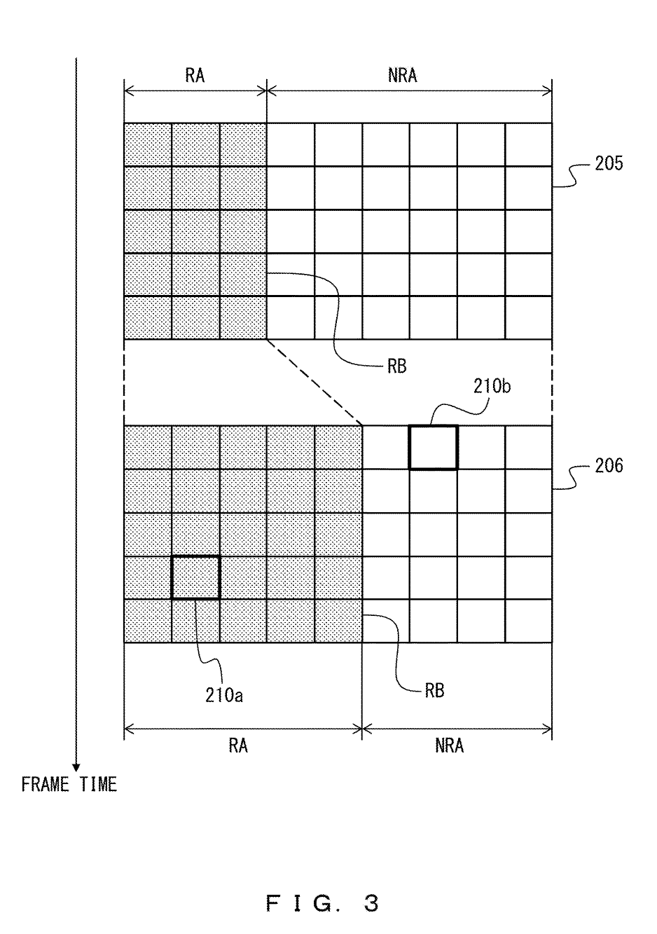

FIG. 2 is a diagram explaining intra-refresh. Pictures 200 to 204 illustrated in FIG. 2 are temporally continuous pictures, and the respective pictures are encoded into P-pictures or B-pictures using a past picture. When the respective pictures 200 to 204 are encoded, a position of a block line to which intra-refresh is applied is shifted by one line in a direction from the 0th line L0 to the 4th line L4 for each of the pictures, and intra-refresh is circulated in the entirety of the picture in a fixed cycle. Here, when a line to which intra-refresh is applied is shifted from a left-hand side to a right-hand side of a screen, a boundary RB between a block line to which intra-refresh is applied and a right-adjacent block line is a refresh boundary. An area on a left-hand side of the refresh boundary RB is a refreshed area, and an area on a right-hand side of the refresh boundary RB is a not-yet-refreshed area. In intra-refresh, when inter-prediction is performed on an encoded block in a refreshed area in a current picture to be encoded, there is reference restriction whereby only a refreshed area in a reference picture needs to be referenced. The reference restriction is described with reference to FIG. 3.

FIG. 3 is a diagram explaining reference restriction in intra-refresh. A picture 206 on a lower side of FIG. 3 is a current picture to be encoded. A picture 205 on an upper side of FIG. 3 is a past encoded picture, namely, a reference picture that is referenced when the current picture to be encoded 206 is encoded.

When a line to which intra-refresh is applied is circulated from a block line on a left-hand end of a picture to a block line on a right-hand end of the picture, in the respective pictures 205 and 206, an area on a left-hand side of a refresh boundary RB is a refreshed area RA, and an area on a right-hand side of the refresh boundary RB is a not-yet-refreshed area NRA.

In the example illustrated in FIG. 3, when inter-prediction by referencing the reference picture 205 is performed on an encoded block 210a within the refreshed area RA of the current picture to be encoded 206, a referable area is limited to the refreshed area RA of the reference picture 205.

Due to this reference restriction, in intra-refresh, the entirety of a picture can be refreshed after intra-refresh is circulated, and recovery from an error generated due to a transmission error can be performed or a video stream can be decoded from the middle. Further, in intra-refresh, a buffer can be reduced in size because an I-picture having a large amount of information is not used, and a delay due to the buffer can be reduced.

Circulation of intra-refresh is not limited to the above circulation from left to right, and may be circulation from right to left, circulation from top to bottom, or circulation from bottom to top.

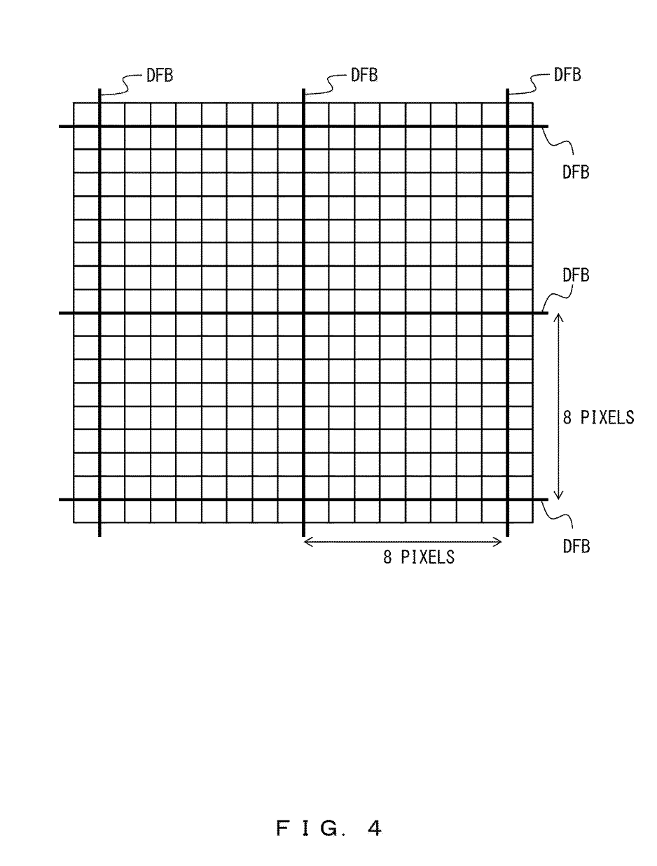

In intra-refresh, a motion vector sometimes fails to be derived even within a referable area due to a relationship between a direction of reference restriction on an encoded block and an image format. Accordingly, in conventional intra-refresh, optimum motion compensation may fail to be performed. In particular, in the moving image encoder 100 including the SAO processing unit 109, as illustrated in FIG. 1, a reference inhibition area may be extended due to the SAO processing and motion compensation, and an optimum prediction image may fail to be generated. This respect is described below with reference to FIGS. 4 to 15.

In the description below, for convenience, a target area in which a motion vector on a current picture to be encoded is restricted is referred to as a vector restriction area, and a boundary is referred to as a vector restriction boundary VB. An area in which reference on a reference picture is allowed is referred to as a referable area, and an area in which reference is not allowed is referred to as a reference inhibition area. A boundary RB between the referable area and the reference inhibition area, such as the refresh area above, is also referred to as a reference restriction boundary.

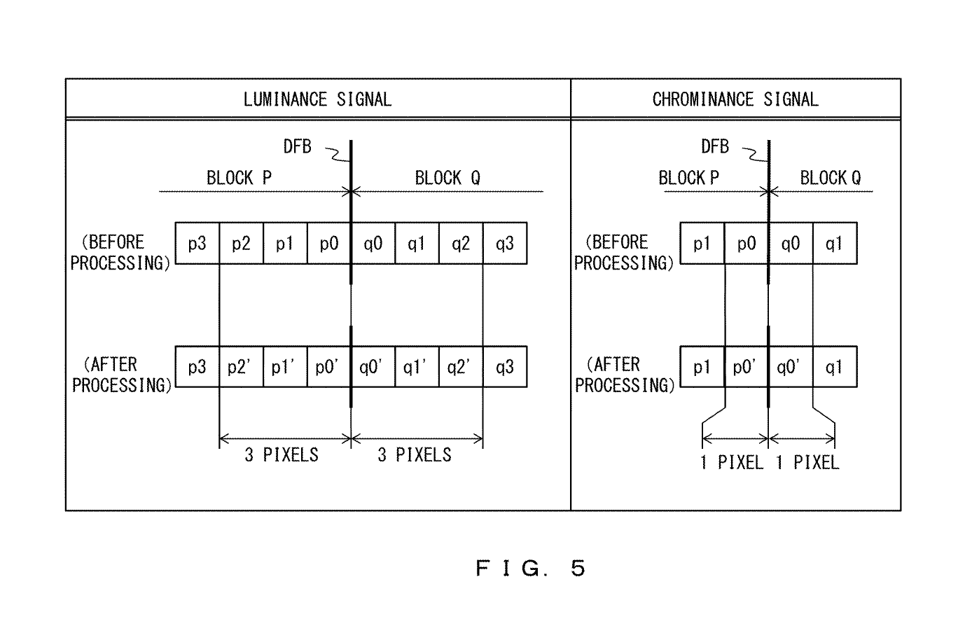

FIG. 4 is a diagram explaining a filter boundary in the DF processing. FIG. 5 is a diagram explaining a pixel influenced by the DF processing.

The DF processing unit 108 of the moving image encoder 100 illustrated in FIG. 1 performs the DF processing for reducing block distortion on a decoded image (a decoded picture) input from the decoded image generator 107, as described above. At this time, in the decoded image, a block boundary DFB of an 8×8 pixel unit at minimum is a target on which the DF processing is performed, as illustrated in FIG. 4. Hereinafter, the boundary DFB on which the DF processing is performed is referred to as a DF boundary.

When the DF processing is applied, data (a luminance signal and a chrominance signal) of a pixel after the DF processing is described below.

First, in a luminance signal, data of 4 leftward pixels and 4 rightward pixels at maximum from the DF boundary DFB is referenced, and data of 3 leftward pixels and 3 rightward pixels may be changed as a result of the DF processing, as illustrated in FIG. 5. The data of 3 leftward pixels and 3 rightward pixels in the luminance signal is calculated, for example, according to Expressions (1-1) to (1-6) below.

p0′=Clip3(p0−2×tC, p0+2×tC, (p2+2×p1+2×p0+2×q0+q1+4)>>3) (1-1)

p1′=Clip3(p1−2×tC, p1+2×tC, (p2+p1+p0+q0+2)>>2) (1-2)

p2′=Clip3(p2−2×tC, p2+2×tC, (2×p3+3×p2+p1+p0+q0+4)−3) (1-3)

q0′=Clip3(q0−2×tC, q0+2×tC, (p1+2×p0+2×q0+2×q1+q2+4)>>3) (1-4)

q1′=Clip3(q1−2×tC, q1+2×tC, (p0+q0+q1+q2+2)>>2) (1-5)

q2′=Clip3(q2−2×tC, q2+2×tC, (p0+q0+q1+3×q2+2×q3+4)>>3) (1-6)

The tC in Expressions (1-1) to (1-6) represents a variable (an integer value) for controlling filter intensity. The Clip3 (x, y, z) represents that clip processing is performed in such a way that the range of z is x≦z≦y. “>>3” and “>>2” represent a 3-bit arithmetic right-shift operation and a 2-bit arithmetic right-shift operation, respectively.

In a chrominance signal, data of 2 leftward pixels and 2 rightward pixels from the DF boundary DFB is referenced, and data of 1 leftward pixel and 1 rightward pixel may be changed as a result of the DF processing, as illustrated in FIG. 5. The data of 1 leftward pixel and 1 rightward pixel in the chrominance signal is calculated according to Expressions (2-1) to (2-3) below.

Δ=Clip3(−tC, tC, ((((q0−p0)<<2)+p1−q1+4)>>3)) (2-1)

p0′=Clip1C(p0+Δ) (2-2)

q0′=Clip1C(q0−Δ) (2-3)

The Clip1C(a) represents that clip processing is performed in such a way that the range of a is 0≦a≦b, where b is a maximum value that can be expressed by using a pixel bit depth of a chrominance signal.

Pixel values of pixels that are arranged in a vertical direction of the DF boundary DFB in a horizontal direction are also influenced similarly to pixels that are arranged in a horizontal direction in FIG. 5, although this is not illustrated.

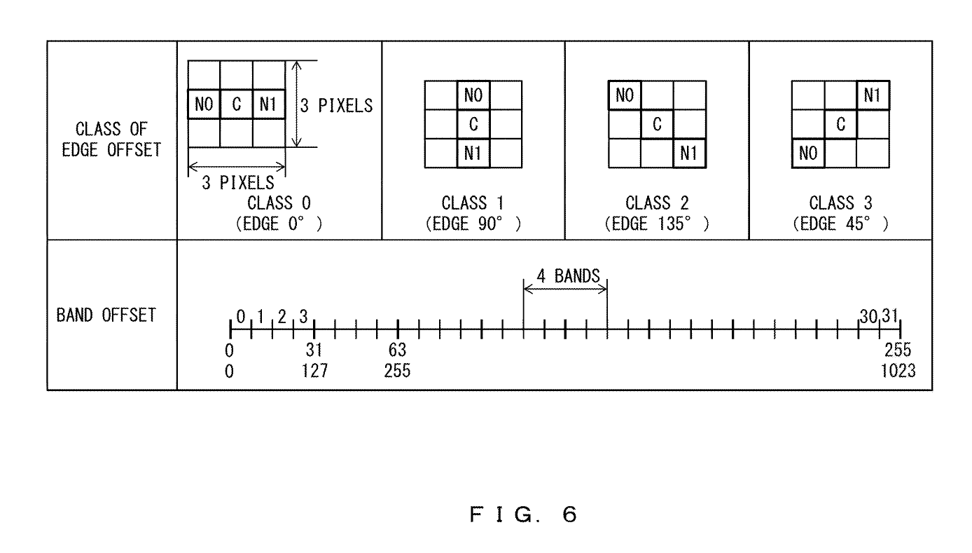

FIG. 6 is a diagram explaining an offset type in the SAO processing.

In the SAO processing unit 109 of the moving image encoder 100 illustrated in FIG. 1, a process for adding or subtracting an offset to/from a pixel value is performed on an image after the DF processing according to a prescribed method, as described above. The offset in the SAO processing is primarily configured of two types of offset, an edge offset type and a band offset type. In the edge offset, an offset value is added to or subtracted from a pixel value of a pixel C that is a target to which an offset is applied according to a relationship between the pixel C and adjacent pixels N0 and N1 in an area of 3×3 pixels with the pixel C as a center, as illustrated in FIG. 6. The relationship between the pixel C and the adjacent pixels N0 and N1 is categorized into four classes, class 0 (Edge0°), class 1 (Edge90°), class 2 (Edge135°), and class 3 (Edge45°). One of the four classes is individually selected for a luminance signal and a chrominance signal in each of the encoded blocks. In the edge offset, each of the classes is further categorized into four categories according to a relative relationship between the pixel C and the two adjacent pixels N0 and N1, and an offset value can be set for each of the categories. In the band offset, the total graduations of a pixel are divided into 32 bands, and an offset that has been set for each of the bands is added to four continuous bands, as illustrated in FIG. 6. The SAO processing unit 109 can also select processing for not executing the edge offset or the band offset (None type).

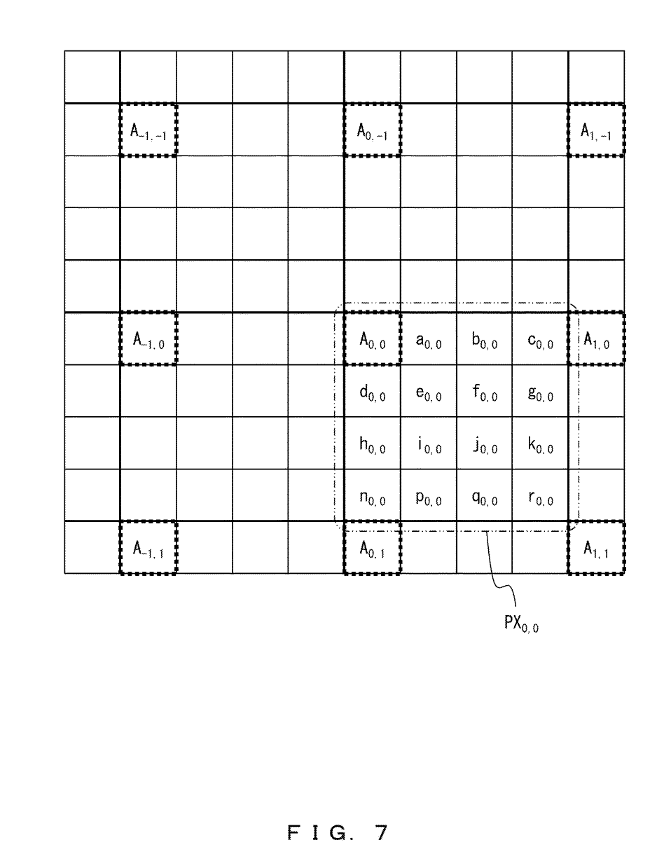

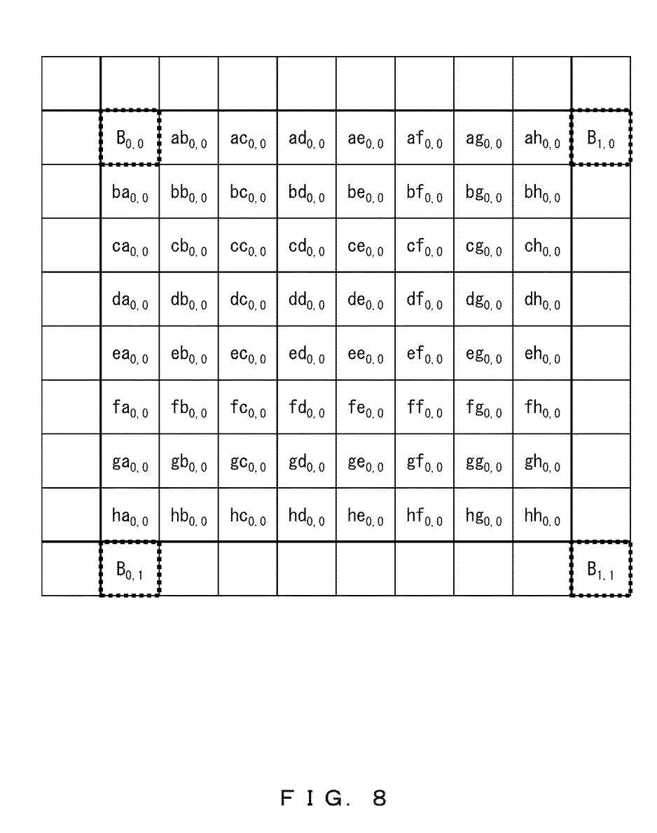

FIG. 7 is a diagram explaining motion compensation on a luminance signal. FIG. 8 is a diagram explaining motion compensation on a chrominance signal.

The motion compensation image signal generator 112 of the moving image encoder 100 illustrated in FIG. 1 performs prescribed processing according to a standard on the basis of a motion vector so as to generate a prediction image of inter-prediction. A method for generating a prediction image of inter-prediction is described here. As an example, when a YUV format is 4:2:0, motion compensation up to ¼ pixel accuracy can be performed on a luminance signal configuring a prediction image, and motion compensation up to ⅛ pixel accuracy can be performed on a chrominance signal.

In motion compensation on a luminance signal in H.265/HEVC, a luminance signal can have motion vector information of ¼ pixel accuracy indicating positions a_{i,j} to r_{i,j}, in addition to a luminance signal pixel value A_{i,j} of integer pixel accuracy, as illustrated in FIG. 7, for example. In FIG. 7, 4×4 squares (16 squares) surrounded with a thick solid line indicate motion vector information for one pixel, and a pixel value A_{i,j} in a square located in a left-upper corner corresponds to a luminance signal of each of the pixels stored in a frame memory. As an example, a pixel value A_{0,0} illustrated in FIG. 7 is a value that is stored in the frame memory as a luminance signal pixel value of one pixel PX_{0,0} in image data.

Pieces of motion vector information of ¼ pixel accuracy indicating positions a_{0,0} to d_{0,0}, h_{0,0}, and n_{0,0} illustrated in FIG. 7 are calculated by using the luminance signal pixel value A_{i,j} of integer pixel accuracy and an 8-tap filter according to Expressions (3-1) to (3-6) below.

a_{0,0}=(−A_{-3,0}+4*A_{-2,0}−10*A_{-1,0}+58*A_{0,0}+17*A_{1,0}−5*A_{2,0}+A_{3,0})>>shift1 (3-1)

b_{0,0}=(−A_{-3,0}+4*A_{-2,0}−11*A_{-1,0}+40*A_{0,0}+40*A_{1,0}−11*A_{2,0}+4*A_{3,0}−A_{4,0})>>shift1 (3-2)

c_{0,0}=(A_{-2,0}−5*A_{-1,0}+17*A_{0,0}+58*A_{1,0}−10*A_{2,0}+4*A_{3,0}−A_{4,0})>>shift1 (3-3)

d_{0,0}=(−A_{0,-3}4*A_{0,2}10*A_{0,-1}+58*A_{0,0}+17*A_{0,1}−5*A_{0,2}+A_{0,3})>>shift1 (3-4)

h_{0,0}=(−A_{0,-3}+4*A_{0,-2}−11*A_{0,-1}+40*A_{0,0}+40*A_{0,1}−11*A_{0,2}+4*A_{0,3}−A_{0,4})>>shift1 (3-5)

n_{0,0}=(A_{0,-2}−5*A_{0,-1}+17*A_{0,0}+58*A_{0,1}−10*A_{0,2}+4*A_{0,3}−A_{0,4})>>shift1 (3-6)

In Expressions (3-1) to (3-6), the shift1 is a value given at Min (4, BitDepthY-8), where BitDepthY is a pixel depth (a bit depth) for a luminance signal.

Pieces of motion vector information of ¼ pixel accuracy indicating positions e_{0,0}, i_{0,0}, p_{0,0}, f_{0,0}, j_{0,0}, q_{0,0}, g_{0,0}, k_{0,0}, and r_{0,0} illustrated in FIG. 7 are respectively calculated by using a_{0,j}, b_{0,j}, and c_{0,j} (j=−3, −2, . . . , 4) of ¼ pixel accuracy and an 8-tap filter according to Expressions (3-7) to (3-15) below.

e_{0,0}=(−a_{0,-3}+4*a_{0,-2}−10*a_{0,-1}+58*a_{0,0}+17*a_{0,1}−5*a_{0,2}+a_{0,3})>>shift2 (3-7)

i_{0,0}=(−a_{0,-3}+4*a_{0,-2}−11*a_{0,-1}+40*a_{0,0}+40*a_{0,1}−11*a_{0,2}+4*a_{0,3}−a_{0,4})>>shift2 (3-8)

p_{0,0}=(a_{0,-2}−5*a_{0,-1}+17*a_{0,0}+58*a_{0,1}−10*a_{0,2}+4*a_{0,3}−a_{0,4})>>shift2 (3-9)

f_{0,0}=(−b_{0,-3}+4*b_{0,-2}−10*b_{0,-1}+58*b_{0,0}+17*b_{0,1}−5*b_{0,2}+b_{0,3})>>shift2 (3-10)

j_{0,0}=(−b_{0,-3}+4*b_{0,-2}−11*b_{0,-1}+40*b_{0,0}+40*b_{0,1}−_{11*}b_{0,2}+4*b_{0,3}−b_{0,4})>>shift2 (3-11)

q_{0,0}=(b_{0,-2}−5*b_{0,-1}+17*b_{0,0}58*b_{0,1}−10*b_{0,2}+4*b_{0,3}−b_{0,4})>>shift2 (3-12)

g_{0,0}=(−c_{0,-3}+4*c_{0,-2}−10*c_{0,-1}+58*c_{0,0}+17*c_{0,1}−5*c_{0,2}+c_{0,3})>>shift2 (3-13)

k_{0,0}=(−c_{0,-3}+4*c_{0,-2}−11*c_{0,-1}+40*c_{0,0}+40*c_{0,1}−11*c_{0,2}+4*c_{0,3}−c_{0,4})>>shift2 (3-14)

r_{0,0}=(c_{0,-2}−5*c_{0,-1}+17*c_{0,0}+58*c_{0,1}−10*c_{0,2}+4*c_{0,3}−c_{0,4})>>shift2 (3-15)

In Expressions (3-7) to (3-15), the shift2 is 6.

As described above, in order to calculate motion vector information of ¼ pixel accuracy for a luminance signal having a pixel for which a pixel value of integer pixel accuracy is A_{i,j} (hereinafter also referred to as a pixel A_{i,j}), pixel values of respective 4 pixels in leftward, rightward, upward, and downward directions of the pixel A_{i,j} need to be referenced.

On the other hand, in motion compensation on a chrominance signal in H.265/HEVC, the chrominance signal can have motion vector information of ⅛ pixel accuracy indicating positions ab_{i,j} to hh_{i,j}, in addition to a chrominance signal pixel value B_{i,j} of integer pixel accuracy, as illustrated in FIG. 8, for example.

In this case, pixel values of ⅛ pixel accuracy indicating vertical positions ab_{0,0} to ah_{0,0} that are the same as a chrominance signal pixel value B_{0,0} of integer pixel accuracy illustrated in FIG. 8 are calculated by using a chrominance signal pixel value B_{i,j} of integer pixel accuracy and a 4-tap filter according to Expressions (4-1) to (4-7) below.

ab_{0,0}=(−2*B_{-1,0}+58*B_{0,0}+10*B_{1,0}−2*B_{2,0})>>shift3 (4-1)

ac_{0,0}=(−4*B_{-1,0}+54*B_{0,0}+16*B_{1,0}−2*B_{2,0})>>shift3 (4-2)

ad_{0,0}=(−6*B_{-1,0}+46*B_{0,0}+28*B_{1,0}−4*B_{2,0})>>shift3 (4-3)

ae_{0,0}=(−4*B_{-1,0}+36*B_{0,0}+36*B_{1,0}−4*B_{2,0})>>shift3 (4-4)

af_{0,0}=(−4*B_{-1,0}+28*B_{0,0}+46*B_{1,0}−6*B_{2,0})>>shift3 (4-5)

ag_{0,0}=(−2*B_{-1,0}+16*B_{0,0}+54*B_{1,0}−4*B_{2,0})>>shift3 (4-6)

ah_{0,0}=(−2*B_{-1,0}+10*B_{0,0}+58*B_{1,0}−2*B_{2,0})>>shift3 (4-7)

In Expressions (4-1) to (4-7), the shift3 is a value given at Min(4, BitDepthC-8), where BitDepthC is a pixel depth (a bit depth) for a chrominance signal.

Pixel values of ⅛ pixel accuracy indicating horizontal positions ba_{0,0} to ha_{0,0} that are the same as the chrominance signal pixel value B_{0,0} of integer pixel accuracy illustrated in FIG. 8 are calculated by using the chrominance signal pixel value B_{i,j} of integer pixel accuracy and a 4-tap filter according to Expressions (4-8) to (4-14) below.

ba_{0,0}=(−2*B_{0,-1}+58*B_{0,0}+10*B_{0,1}−2*B_{0,2})>>shift3 (4-8)

ca_{0,0}=(−4*B_{0,-1}+54*B_{0,0}+16*B_{0,1}−2*B_{0,2})>>shift3 (4-9)

da_{0,0}=(−6*B_{0,-1}+46*B_{0,0}+28*B_{0,1}−4*B_{0,2})>>shift3 (4-10)

ea_{0,0}=(−4*B_{0,-1}+36*B_{0,0}+36*B_{0,1}−4*B_{0,2})>>shift3 (4-11)

fa_{0,0}=(−4*B_{0,-1}+28*B_{0,0}+46*B_{0,1}−6*B_{0,2})>>shift3 (4-12)

ga_{0,0}=(−2*B_{0,-1}+16*B_{0,0}+54*B_{0,1}−4*B_{0,2})>>shift3 (4-13)

ha_{0,0}=(−2*B_{0,-1}+10*B_{0,0}+58*B_{0,1}−2*B_{0,2})>>shift3 (4-14)

Pixel values bX_{0,0} to hX_{0,0} (X=b to h) illustrated in FIG. 8 are respectively calculated by using a pixel value aX_{0,j} (j=−1, 0, 1, or 2) and the 4-tap filter according to

Expressions (4-15) to (4-21) below.

bX_{0,0}=(−2*aX_{0,-1}+58*aX_{0,0}+10*aX_{0,1}−2*aX_{0,2})>>shift2 (4-15)

cX_{0,0}=(−4*aX_{0,-1}+54*aX_{0,0}+16*aX_{0,1}−2*aX_{0,2})>>shift2 (4-16)

dX_{0,0}=(−6*aX_{0,-1}+46*aX_{0,0}+28*aX_{0,1}−4*aX_{0,2})>>shift2 (4-17)

eX_{0,0}=(−4*aX_{0,-1}+36*aX_{0,0}+36*aX_{0,1}−4*aX_{0,2})>>shift2 (4-18)

fX_{0,0})=(−4*aX_{0,-1}+28*aX_{0,0}+46*aX_{0,1}−6*aX_{0,2})>>shift2 (4-19)

gX_{0,0}=(−2*aX_{0,-1}+16*aX_{0,0}+54*aX_{0,1}−4*aX_{0,2})>>shift2 (4-20)

hX_{0,0})=(−2*aX_{0,-1}+10*aX_{0,0}+58*aX_{0,1}−2*aX_{0,2})>>shift2 (4-21)

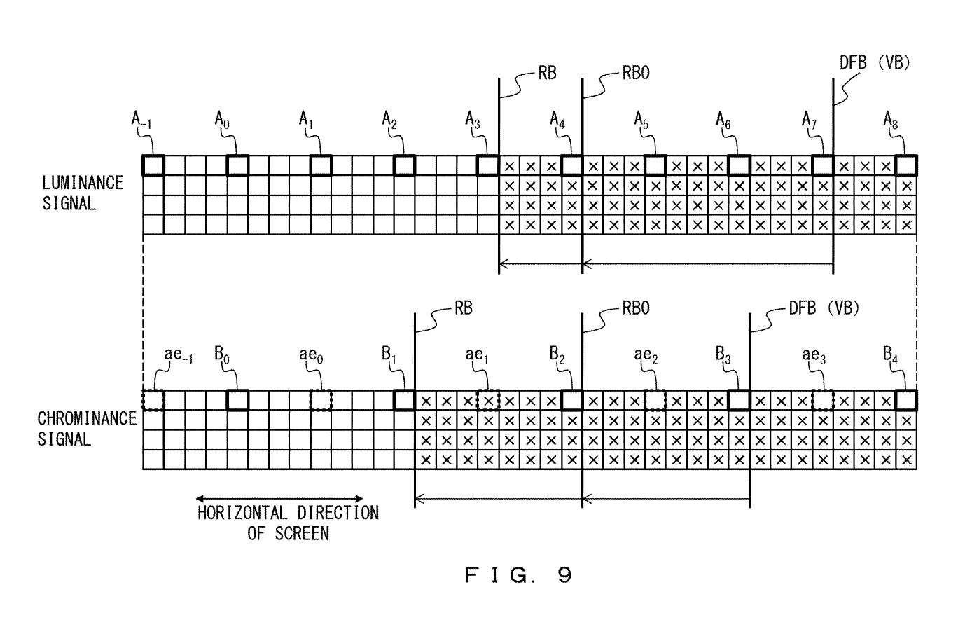

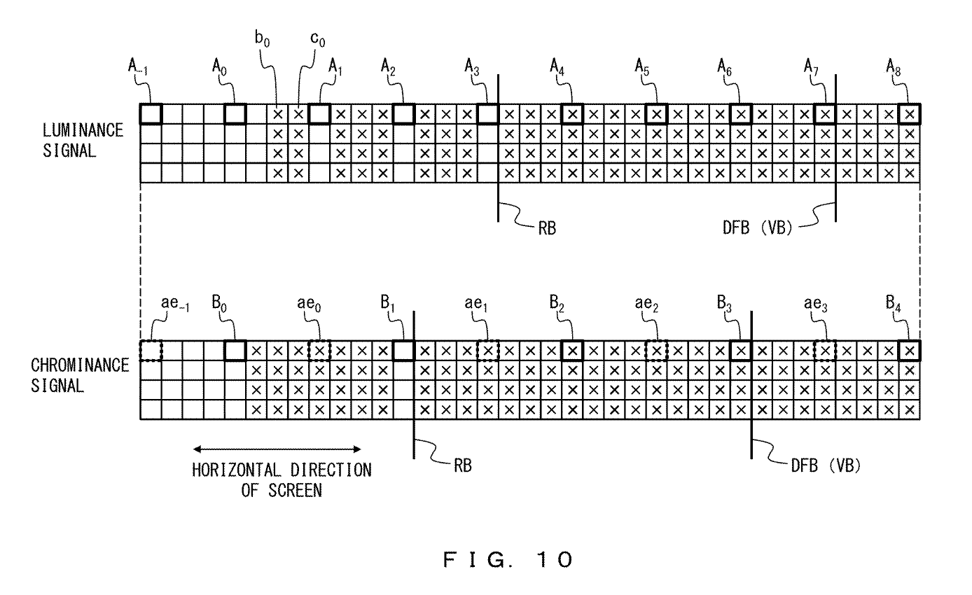

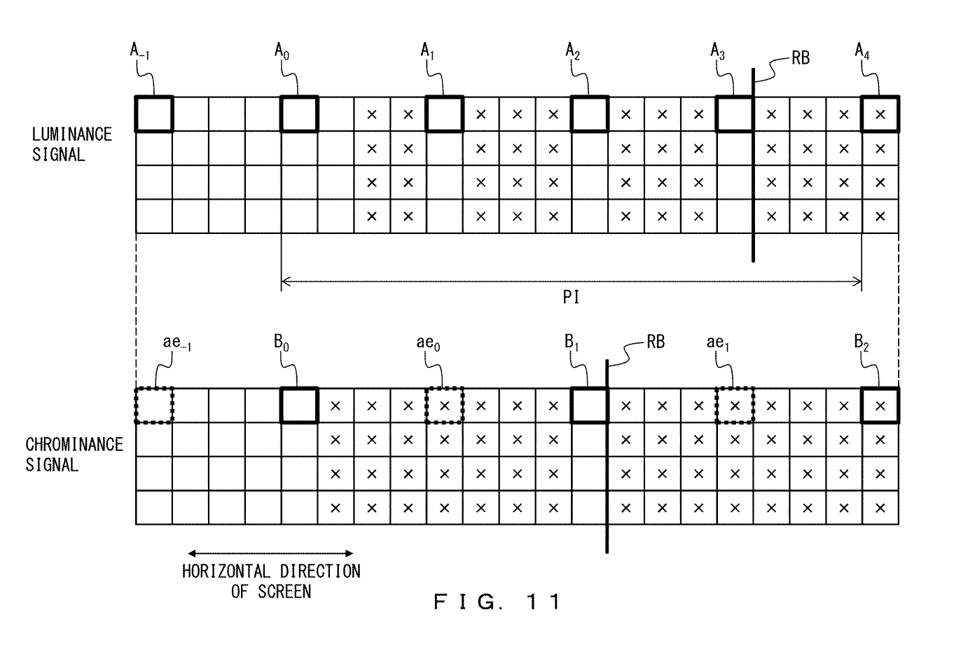

FIG. 9 illustrates a reference restriction boundary when the DF processing and the SAO processing are enabled. FIG. 10 illustrates extension of reference restriction due to motion compensation when the DF processing and the SAO processing are enabled. FIG. 11 is a diagram explaining whether a prediction image can be generated when the DF processing and the SAO processing are enabled.

When respective pictures are encoded according to the H.265/HEVC standard above, it is preferable that the DF processing and the SAO processing be enabled (namely, both the DF processing and the SAO processing be performed) in order to improve image quality. In encoding by using intra-refresh in the moving image encoder 100 of FIG. 1, when the DF processing and the SAO processing are enabled, respective position relationships between a vector restriction boundary VB and a reference restriction boundary RB (RBO) in a luminance signal and a chrominance signal are as illustrated in FIG. 9.

A square marked with “x” in FIGS. 9 to 11 represents that a pixel value that corresponds to the position of the square is inhibited from being referenced. The Aₖ in FIGS. 9 to 11 represents a pixel value of a luminance signal of integer pixel accuracy, but the expression “pixel Aₖ” or “integer pixel Aₖ” is also used in the description below. The Bₖ in FIGS. 9 to 11 represents a pixel value of a chrominance signal of integer pixel accuracy, but the expression “pixel Bₖ” or “integer pixel Bₖ” is also used in the description below. The subscript k of the pixel values Aₖ and Bₖ represents an index indicating a coordinate of a pixel in a horizontal direction. In general, the luminance signal and the chrominance signal are managed by using a coordinate with a left-hand end of a picture as a reference. The luminance signal and the chrominance signal can be managed by using only a relative coordinate because pixels are configured from a sampling position of 4:2:0 when the image format is 4:2:0. When the image format is 4:2:0, one integer pixel in the chrominance signal corresponds to two integer pixels in the luminance signal, as illustrated in FIG. 9.

In the luminance signal illustrated in FIG. 9, a vertical line passing a right-hand side of an integer pixel is a vector restriction boundary VB that is a vector restriction position when a reference picture is encoded. The vector restriction boundary VB matches a boundary of an encoded-block unit, and also matches a DF boundary DFB. Further, before the DF processing is performed, the vector restriction boundary VB also matches a reference restriction area (a refresh boundary) RB. However, when the DF processing is performed, in the luminance signal, data of 3 integer-unit pixels located on a left-hand side of the DF boundary DFB may be changed as a result of rewriting processing in which a pixel located on a right-hand side of the DF boundary DFB is referenced, as described above. Accordingly, a reference restriction boundary (a refresh boundary) RBO after the DF processing and before the SAO processing is shifted in a leftward direction of the DF boundary DFB by 3 pixels so as to be a vertical line passing a right-hand end of an integer pixel A₄. When the SAO processing is further performed, one pixel that is right-adjacent to a pixel C is referenced, as described above. Therefore, a position of a reference restriction boundary RB after the SAO processing in the luminance signal is further shifted in a leftward direction of the refresh boundary RBO before the SAO processing by one pixel so as to be a vertical line passing a right-hand side of an integer pixel A₃.

At this time, in the chrominance signal, a vertical line passing a right-hand end of an integer pixel B₃ that corresponds to an integer pixel A₆ in the luminance signal is a vector restriction boundary VB, as illustrated in FIG. 9. When the DF processing is performed, in the chrominance signal, data of one integer-unit pixel located on a left-hand side of a DF boundary may be changed as a result of rewriting processing in which a pixel located on a right-hand side of the DF boundary DFB is referenced. When the SAO processing is further performed, one pixel that is right-adjacent to a pixel C is referenced, as described above. Accordingly, a reference restriction boundary RB after the SAO processing in the chrominance signal is further shifted in a leftward direction of an integer pixel B₂ by one pixel so as to be a vertical line passing a right-hand side of an integer pixel B₁.

Now, a case is considered in which a prediction image for an inter-prediction block in a refreshed area illustrated in FIG. 3 is generated. In this case, a prediction image needs to be generated without referencing a pixel located on a right-hand side of a refresh boundary RB after the SAO processing (namely, a not-yet-refreshed area). However, in motion compensation on a luminance signal, an at most 8-tap filter is used. Therefore, when a pixel value of decimal pixel accuracy of a pixel is calculated, pixel values of 4 integer pixels located on a right-hand side of the pixel needs to be referenced. Accordingly, in a case in which pixels located on the right-hand side of the refresh boundary RB after the SAO processing are included in the 4 integer pixels located on the right-hand side of the pixel, a pixel value of decimal pixel accuracy of the pixel fails to be calculated. As an example, pixel values b₀ and C₀ of ¼ accuracy of a pixel A₀ are calculated by using a pixel value A₄ that is located 4 pixels in a rightward direction, as expressed in Expressions (3-2) and (3-3) above. Therefore, when the pixel value A₄ fails to be referenced, the pixel values b₀ and C₀ fail to be calculated. Consequently, in a case in which the refresh boundary RB after the SAO processing in the luminance signal is a vertical line passing a right-hand side of a pixel A₃, a reference inhibition area is also generated on a left-hand side of the refresh boundary RB (namely, in the refreshed area), as illustrated in FIGS. 10 and 11.

Similarly, in motion compensation on a chrominance signal, a 4-tap filter is used. Therefore, when pixels located on a right-hand side of a refresh boundary RB after the SAO processing are included in 2 pixels located on a right-hand side of a pixel, a pixel value of decimal pixel accuracy of the pixel fails to be calculated. Consequently, in a case in which the refresh boundary RB after the SAO processing in the chrominance signal is a vertical line passing a right-hand side of a pixel B₁, the reference inhibition area is also generated on a left-hand side of the refresh boundary RB (namely, in the refreshed area), as illustrated in FIGS. 10 and 11.

In motion compensation, a motion vector of a chrominance (a chrominance vector) is calculated on the basis of a motion vector of luminance (a luminance vector). As an example, in the image format of 4:2:0, when a luminance vector is mvLX, a chrominance vector mvCLX is expressed according to Expressions (5-1) and (5-2) below.

mvCLX[0]=mvLX[0] (5-1)

mvCLX[1]=mvLX[1] (5-2)

Here, the luminance vector is assumed to have ¼ pixel accuracy (a value of four times integer pixel accuracy).

A left-upper-end position of a predition image of a prediction block (xPb, yPb) is expressed according to Expressions (6-1) to (6-4) below, when the left-upper-end position is divided into luminance integer coordinates (xIntL, yIntL) and luminance decimal coordinates (xFracL, yFracL).

xIntL=xPb+(mvLX[0]>>2) (6-1)

yIntL=yPb+(mvLX[1]>>2) (6-2)

xFracL=mvLX[0]&3 (6-3)

yFracL=mvLX[1]&3 (6-4)

Here, xFracL and yFracL are managed by using ¼ pixel accuracy. When each of xFracL and yFracL is 0, the position of the predictive image is integer pixel. When each of xFracL and yFracL is 1, the position of the predictive image is 0.25 pixel. When each of xFracL and yFracL is 2, the position of the predictive image is 0.5 pixel. When each of xFracL and yFracL is 3, the position of the predictive image is 0.75 pixel.

Similarly, the left-upper-end position of the prediction image of the prediction block (xPb, yPb) is expressed according to Expressions (7-1) to (7-4) below, when the left-upper-end position is divided into chrominance integer coordinates (xIntC, yIntC) and chrominance decimal coordinates (xFracC, yFracC).

xIntC=(xPb/2)+(mvCLX[0]>>3) (7-1)

yIntC=(yPb/2)+(mvCLX[1]>>3) (7-2)

xFracC=mvCLX[0]&7 (7-3)

yFracC=mvCLX[1]&7 (7-4)

Here, xFracC and yFracC are managed by using ⅛ pixel accuracy.

As described above, in the luminance signal, a prediction image is configured of pixels of the same accuracy with a pixel in a left-upper-end position as a reference. The size of the prediction image is the same as that of an inter-prediction block, but in encoding in the 4:2:0 format, the prediction image needs to conform to the 4:2:0 format. Namely, prediction images in all portions of a reference picture are generated in the 4:2:0 format. The luminance signal and the chrominance signal do not always have pixels of the same accuracy. Referring to FIG. 11 again, whether a prediction image in the 4:2:0 format can be generated when the DF processing and the SAO processing are enabled is now described. For simplicity, a prediction image PI has the size of 4 pixels in a horizontal direction. In FIG. 11, a case is considered in which an integer pixel A₀ is located in a left-upper-end position of the prediction image PI, and a prediction image of a luminance signal is configured of integer pixels from a pixel A₀ to a pixel A₃. In this case, in order to generate a prediction image in the 4:2:0 format, a prediction image of a chrominance signal needs to be configured of integer pixels B₀ and B₁. Both of the integer pixels B₀ and B₁ in the chrominance signal are referable, as illustrated in FIG. 11. Accordingly, in a case in which the prediction image of the luminance signal is configured of the integer pixels from the pixel A₀ to the pixel A₃, the prediction image in the 4:2:0 format can be generated.

In FIG. 11, in a case in which an integer pixel A₋₁ is located in a left-upper-end position of a prediction image, and a prediction image of a luminance signal is configured of integer pixels from a pixel A₋₁ to a pixel A₂, a prediction image of a chrominance signal needs to be configured of pixels ae₋₁ and ae₀ in the 4:2:0 format. However, the pixel ae₀ is inhibited from being referenced as a result of motion compensation, as illustrated in FIG. 11, and therefore a motion vector fails to be derived. Accordingly, in a case in which the prediction image of the luminance signal is configured of the integer pixels from the pixel A₋₁ to the pixel A₂, a prediction image in the 4:2:0 format fails to be generated. This shows that a motion vector that fails to be calculated even from an integer pixel in a referable area exists.

The problem above can occur, for example, when the DF processing is disabled and the SAO processing is enabled.

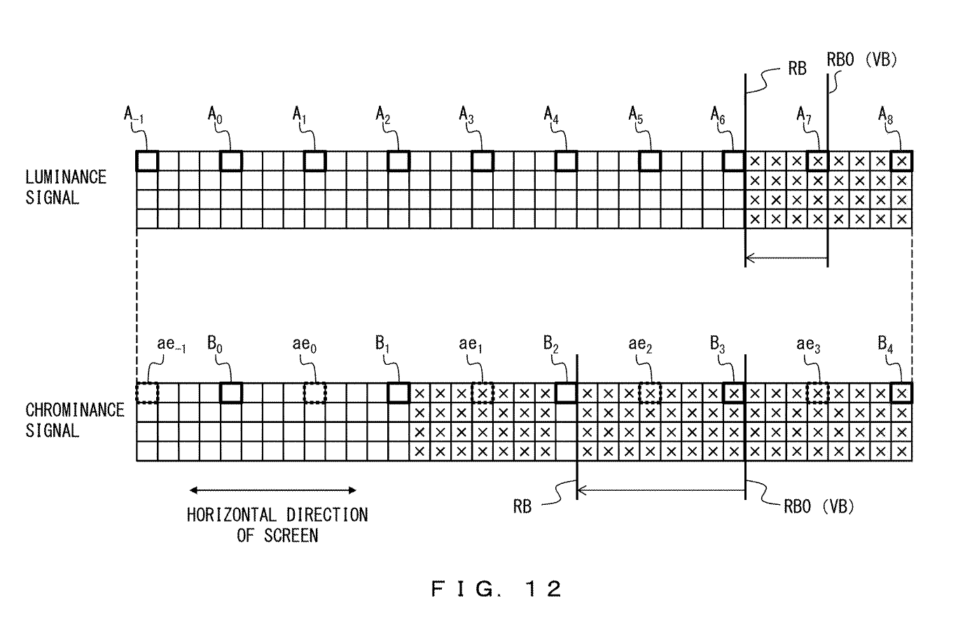

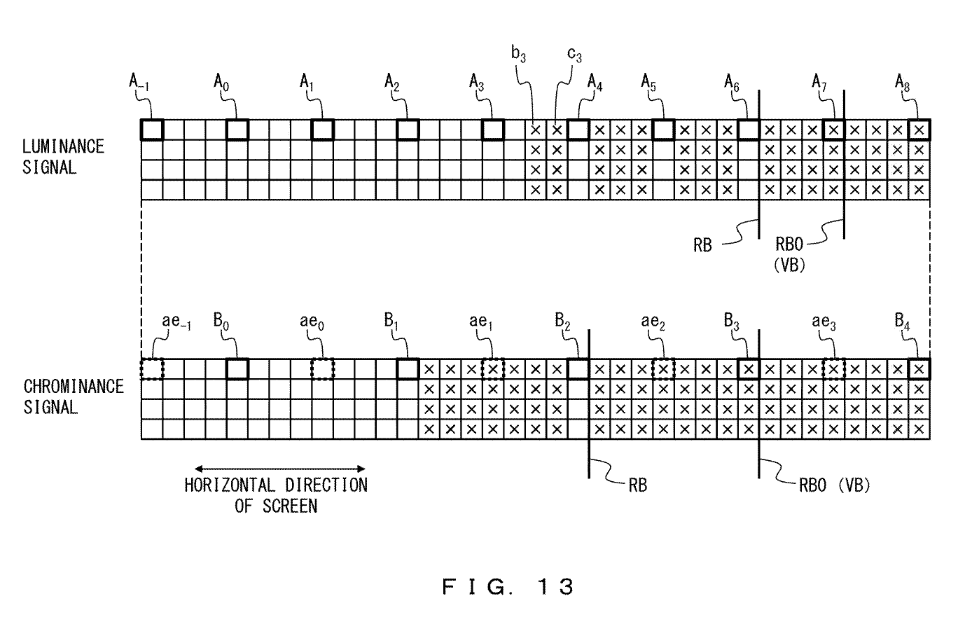

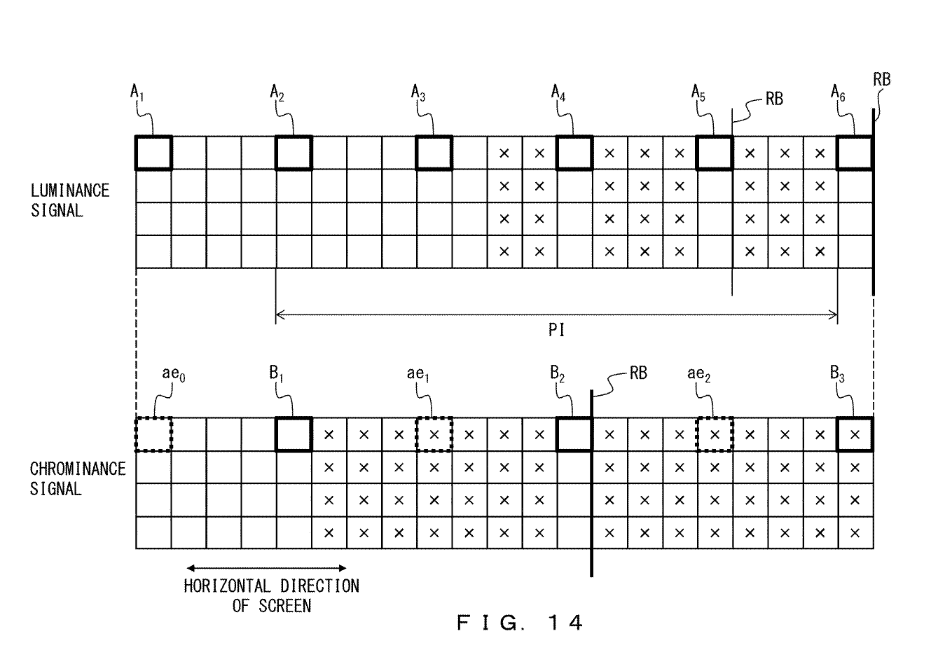

FIG. 12 illustrates a reference restriction boundary when the DF processing is disabled and the SAO processing is enabled. FIG. 13 illustrates extension of reference restriction due to motion compensation when the DF processing is disabled and the SAO processing is enabled. FIG. 14 is a diagram explaining whether a prediction image can be generated when the DF processing is disabled and the SAO processing is enabled.

In a case in which the DF processing is disabled, and only the SAO processing is performed on a decoded image, respective position relationships between a vector restriction boundary VB and a reference restriction boundary (a refresh area) RB in a luminance signal and a chrominance signal are as illustrated in FIG. 12.

In FIGS. 12 to 14, a square marked with “x” represents that a pixel value that corresponds to the position of the square is inhibited from being referenced. The Aₖ in FIGS. 12 to 14 represents a pixel value of a luminance signal of integer pixel accuracy, but the expression “pixel Aₖ” or “integer pixel Aₖ” is also used in the description below. The Bₖ in FIGS. 12 to 14 represents a pixel value of a chrominance signal of integer pixel accuracy, but the expression “pixel Bₖ” or “integer pixel Bₖ” is also used in the description below.

In the luminance signal illustrated in FIG. 12, a vertical line passing a right-hand side of a pixel A₇ is a vector restriction boundary VB that is a vector restriction position when a reference picture is encoded, similarly to the luminance signal in FIG. 9. The vector restriction boundary VB matches a refresh boundary RBO before the SAO processing is performed. When the SAO processing is performed, one pixel that is right-adjacent to a pixel C is referenced, as described above. Accordingly, a position of a refresh boundary RB after the SAO processing in the luminance signal is shifted one pixel in a leftward direction of the refresh boundary RBO before the SAO processing so as to be a vertical line passing a right-hand side of a pixel A₆.

At this time, in a chrominance signal, a vertical line passing a right-hand side of a pixel B₃ that corresponds to a pixel value A₆ in the luminance signal is a vector restriction boundary VB, as illustrated in FIG. 12. When the SAO processing is performed, one pixel that is right-adjacent to a pixel C is referenced, as described above. Accordingly, a refresh boundary RB after the SAO processing in the chrominance signal is a vertical line passing a right-hand side of a pixel B₂ that corresponds to a pixel A₄ in the luminance signal.

Accordingly, also when the DF processing is disabled, and the SAO processing is enabled, a reference inhibition area is generated on a left-hand side of the refresh boundary RB after the SAO processing (namely, a refreshed area) as a result of motion compensation, as illustrated in FIGS. 13 and 14.

In the examples illustrated in FIGS. 13 and 14, in a case in which a prediction image having the size of 4 pixels in a horizontal direction is generated, when an integer pixel A₂ is located in a left-upper-end position of a prediction image, and a prediction image PI is configured of integer pixels from a pixel A₂ to a pixel A₅, a prediction image in the 4:2:0 format can be generated. However, when an integer pixel A₁ is located in a left-upper-end position of a prediction image, and a prediction image of the luminance signal is configured of integer pixels from a pixel A₁ to a pixel A₄, a pixel ae₁ in the chrominance signal that corresponds to the pixels A₃ and A₄ in the luminance signal is inhibited from being referenced. Accordingly, in the examples illustrated in FIGS. 13 and 14, a prediction image in the 4:2:0 format fails to be generated from 4 pixels from the pixel A₁ to the pixel A₄ in the luminance signal. Further, in the examples illustrated in FIGS. 13 and 14, a chrominance signal in a position that corresponds to an integer pixel A₅ is inhibited from being referenced, and therefore a prediction image in the 4:2:0 format fails to be generated by using the pixels A₅ and A₆. Accordingly, a motion vector of the luminance signal of an integer pixel A₆ fails to be calculated practically, and a refresh boundary RB after the SAO processing is practically a boundary between the integer pixels A₅ and A₆.

The reference restriction above is a restriction in a horizontal direction, but in the 4:2:0 format, a similar reference restriction also occurs in a vertical direction, namely, when areas on an upper side and a lower side of a refresh boundary in the horizontal direction are refreshed areas. Further, the reference restriction above does not occur only in the 4:2:0 format but also in the 4:2:2 format. A resolution in the horizontal direction in the 4:2:2 format is the same as that in the 4:2:0 format. Accordingly, in the intra-refresh of an image in the 4:2:2: format, when an area on a left-hand side of a refresh boundary in the vertical direction is a refreshed area, restriction similar to the reference restriction above occurs.

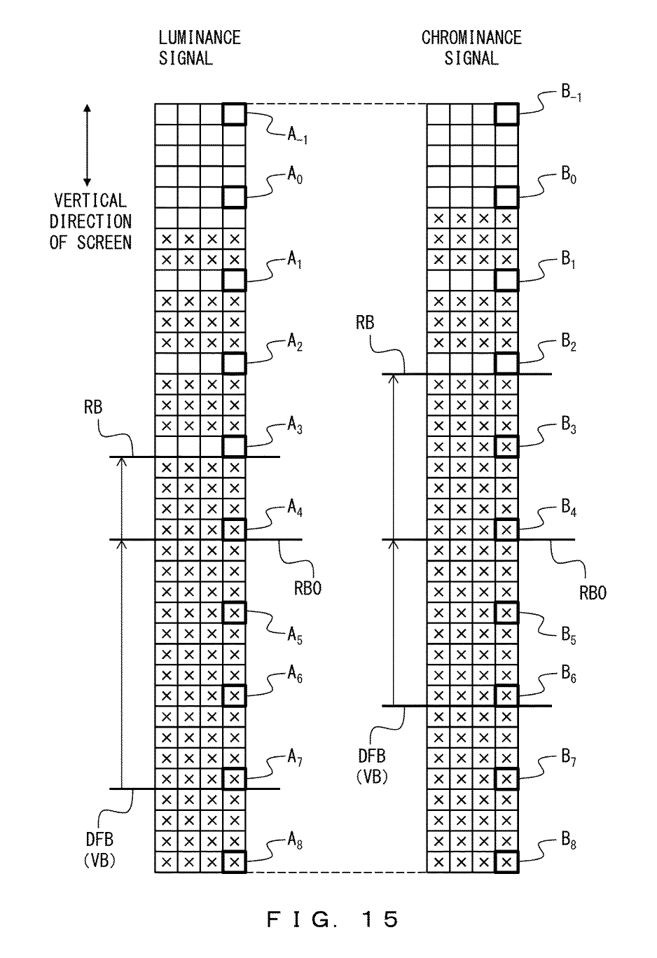

In the intra-refresh of an image in the 4:2:2 format, reference restriction in a case in which an area on an upper side of a refresh boundary in the horizontal direction is a refreshed area is as illustrated in FIG. 15, for example.

FIG. 15 illustrates reference restriction in a vertical direction of a screen in the 4:2:2 format. FIG. 15 illustrates reference restriction of a luminance signal and a chrominance signal when the DF processing and the SAO processing are enabled. In FIG. 15, a square marked with “x” represents that a pixel value that corresponds to the position of the square is inhibited from being referenced. The Aₖ in FIG. 15 represents a pixel value of a luminance signal of integer pixel accuracy, but the expression “pixel Aₖ” or “integer pixel Aₖ” is also used in the description below. The Bₖ in FIG. 15 represents a pixel value of a chrominance signal of integer pixel accuracy, but the expression “pixel Bₖ” or “integer pixel Bₖ” is also used in the description below. The subscript k of the pixel values Aₖ and Bₖ in FIG. 15 represents an index indicating a coordinate of a pixel in a vertical direction.

In the example illustrated in FIG. 15, an area on an upper side of a reference restriction boundary (a refresh boundary) in a horizontal direction is a referable area. Therefore, a refresh boundary RBO of a luminance signal after the DF processing and before the SAO processing is shifted to a position 3 pixels in an upper direction of a DF boundary DFB (a vector boundary VB). When the SAO processing is performed, a refresh boundary RB of a luminance signal after the SAO processing is further shifted 1 pixel in an upper direction. Similarly, a refresh boundary RB of a color signal after the SAO processing is shifted in an upper direction of the DF boundary by 4 pixels.

In the 4:2:2 format, a color vector mvCLX is expressed according to Expressions (8-1) and (8-2) below, where a luminance vector is mvLX.

mvCLX[0]=mvLX[0] (8-1)

mvCLX[1]=mvLX[1]*2 (8-2)

A position on a left-upper-end position of a prediction image in a block (xPb, yPb) is expressed according to Expressions (9-1) to (9-4) below, when the position is divided into luminance integer coordinates (xIntL, yIntL) and luminance docimal coordinates (xFracL, yFracL).

xIntL=xPb+(mvLX[0]>>2) (9-1)

yIntL=yPb+(mvLX[1]>>2) (9-2)

xFracL=mvLX[0]&3 (9-3)

yFracL=mvLX[1]&3 (9-4)

Similarly, the left-upper-end position of the predication image in the block (xPb, yPb) is expressed according to Expressions (10-1) to (10-4) below, when the position is divided into color difference integer coordinates (xIntC, yIntC) and chrominance decimal coordinates (xFracC, yFracC).

xIntC=(xPb/2)+(mvCLX[0]>>3) (10-1)

yIntC=(yPb/1)+(mvCLX[1]>>3) (10-2)

xFracC=mvCLX[0]&7 (10-3)

yFracC=mvCLX[1]&7 (10-4)

Similarly to the 4:2:0 format, in encoding in 4:2:2 format, a prediction image needs to conform to the 4:2:2 format. As an example, in the example illustrated in in FIG. 15, a case is considered in which assume that an integer pixel A₋₁ is located in a left-upper-end position of a prediction image, and the prediction image having the size of 4 pixels is configured in a vertical direction from a pixel A₋₁ to a pixel A₂. In this case, in order to generate a prediction image in the 4:2:2 format, a prediction image of a chrominance signal needs to be configured of integer pixels B₋₁ and B₁. As illustrated in FIG. 15, both of the integer pixels B₋₁ and B₁ in the chrominance signal are referable. Accordingly, when a prediction image of a luminance signal is configured of integer pixels from the pixel A₋₁ to the pixel A₂, a prediction image in the 4:2:2 format can be generated. Stated another way, when reference restriction is set in a vertical direction in the 4:2:2 format, a motion vector can be calculated on the basis of integer pixels within a referable area.

As described above, in conventional encoding of a moving image in which the SAO processing is performed, a motion vector may fail to be calculated even within a referable area due to a relationship between a direction of reference restriction on an encoded block and an image format, and optimum motion compensation may fail to be performed. Accordingly, an optimum prediction image may fail to be generated, and deterioration in image quality due to encoding may be remarkable. Reference needs to be inhibited specially even within a referable area, and processing becomes complicated.

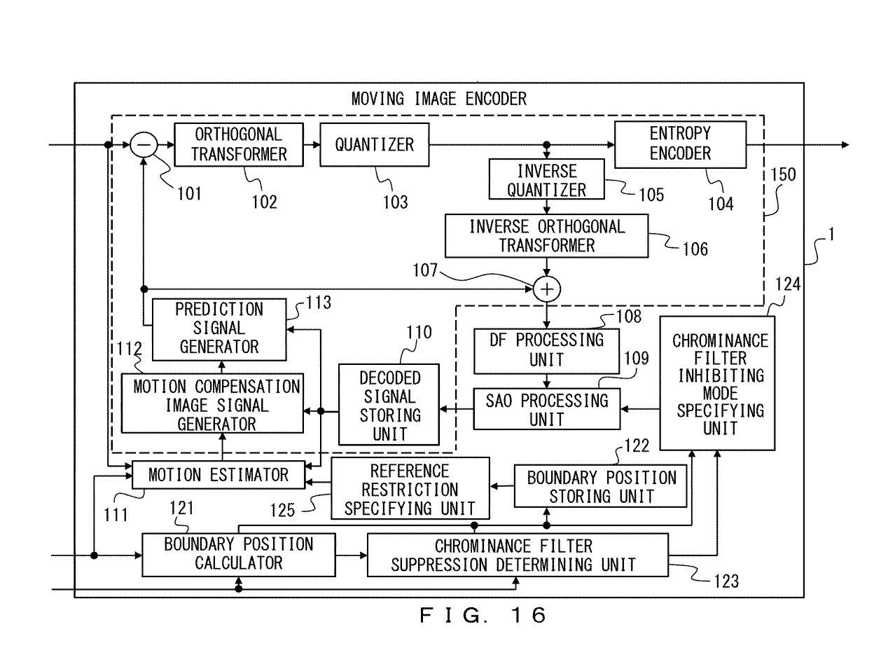

FIG. 16 is a block diagram illustrating a functional configuration of a moving image encoder according to an embodiment.

As illustrated in FIG. 16, a moving image encoder 1 according to the embodiment includes a prediction error signal generator 101, an orthogonal transformer 102, a quantizer 103, an entropy encoder 104, an inverse quantizer 105, an inverse orthogonal transformer 106, and a decoded image generator 107. The moving image encoder 1 also includes a DF processing unit 108, an SAO processing unit 109, a decoded signal storing unit 110, a motion estimator 111, a motion compensation image signal generator 112, and a prediction signal generator 113. The moving image encoder 1 further includes a boundary position calculator 121, a boundary position storing unit 122, a chrominance filter suppression determining unit 123, a chrominance filter inhibiting mode specifying unit 124, and a reference restriction specifying unit 125.

The moving image encoder 1 illustrated in FIG. 16 is broadly divided into the motion estimator 111, an encoder 150, filer processing units 108 and 109, and a reference restriction controller. The motion estimator 111 derives a motion vector used for inter-prediction encoding. The encoder 150 performs orthogonal transformation and quantization on an error image between a prediction image generated on the basis of the motion vector and an original image so as to perform encoding, and performs inverse quantization and inverse orthogonal transformation on the quantized signal so as to recover a reference picture used to derive the motion vector. The filter processing units 108 and 109 performs filtering for improving deterioration in image quality or the like at a block boundary of the recovered image. The reference restriction controller suppresses extension of a reference inhibition area in motion estimation in which a reference picture is referenced.

The prediction error signal generator 101, the orthogonal transformer 102, the quantizer 103, and the entropy encoder 104 in the moving image encoder 1 illustrated in FIG. 16 respectively have the same functions as the functions of respective units of the moving image encoder 100 illustrated in FIG. 1. Similarly, the inverse quantizer 105, the inverse orthogonal transformer 106, the decoded image generator 107, and the DF processing unit 108 in the moving image encoder 1 illustrated in FIG. 16 respectively have the same functions as the functions of respective units of the moving image encoder 100 illustrated in FIG. 1. Further, the decoded image storing unit 110, the motion compensation image signal generator 112, and the prediction signal generator 113 respectively have the same functions as the functions of respective units of the moving image encoder 100 illustrated in FIG. 1.

The boundary position calculator 121, the boundary position storing unit 122, the chrominance filter suppression determining unit 123, the chrominance filter inhibiting mode specifying unit 124, and the reference restriction specifying unit 125, and the SAO processing unit 109 and the motion estimator 111 in the moving image encoder 1 illustrated in FIG. 16 respectively have the functions below.

In motion estimation on a current picture to be encoded, the boundary position calculator 121 calculates a position of a reference restriction boundary RB before the SAO processing on a reference picture, and also calculates a reference restriction type. The boundary position calculator 121 calculates a position of a reference restriction boundary RBO before the SAO processing on the basis of a position of a vector restriction boundary VB indicating a vector restriction area including a plurality of encoded blocks that are targets for vector restriction on the current picture to be encoded, and information indicating whether the DF processing is enabled or disabled. The boundary position calculator 121 also calculates a reference restriction type from a combination of a referable area and a reference inhibition area by using the position of the reference restriction boundary RBO before the SAO processing as a reference. The boundary position calculator 121 outputs the calculated position of the reference restriction boundary RBO before the SAO processing to the boundary position storing unit 122 and the chrominance filter inhibiting mode specifying unit 124, and also outputs the calculated reference restriction type to the chrominance filter suppression determining unit 123.

The boundary position storing unit 122 stores the reference restriction boundary RBO before the SAO processing of the current picture to be encoded until the current picture to be encoded is no longer referenced, in case that the current picture to be encoded be referenced in motion estimation performed on a subsequent picture to be encoded.

The chrominance filter suppression determining unit 123 determines a chrominance filter, i.e., whether the SAO processing on a chrominance signal is suppressed. The chrominance filter suppression determining unit 123 determines whether the chrominance filter is suppressed on the basis of the reference restriction type calculated by the boundary position calculator 121 and image format information (namely, information such as 4:2:2 or 4:2:0). The chrominance filter suppression determining unit 123 outputs a determination result (chrominance filter suppression information) to the chrominance filter inhibiting mode specifying unit 124, and also outputs the reference restriction type to the chrominance filter inhibiting mode specifying unit 124.

The chrominance filter inhibiting mode specifying unit 124 specifies an SAO inhibiting mode for inhibiting a mode for referencing a pixel within a reference inhibition area, from among chrominance filters. The chrominance filter inhibiting mode specifying unit 124 specifies the SAO inhibiting mode on the basis of the position of the reference restriction boundary RB and the reference restriction type that have been calculated by the boundary position calculator 121, and the determination result (the chrominance filter suppression information) of the chrominance filter suppression determining unit. The chrominance filter inhibiting mode specifying unit 124 outputs the specified SAO inhibiting mode to the SAO processing unit 109.

The SAO processing unit 109 adds or subtracts an offset to/ from a pixel value according to the chrominance filter selected from the chrominance filters (SAO modes) other than the SAO inhibiting mode determined by the chrominance filter inhibiting mode specifying unit 124, in an image after the DF processing. The SAO processing unit 109 stores the image after the SAO processing in the decoded image storing unit 110.

The reference restriction specifying unit 125 specifies a final position of the reference restriction boundary RB of a luminance signal after the SAO processing on the basis of the position of the reference restriction boundary RBO before the SAO processing of the reference picture that has been read from the boundary position storing unit 122.

The motion estimator 111 performs motion estimation using only the referable area on the basis of a position of the vector restriction boundary VB on the current picture to be encoded and the position of the reference restriction boundary RB specified by the reference restriction specifying unit 125 so as to derive a motion vector.

Processes that are respectively performed by the boundary position calculator 121, the boundary position storing unit 122, the chrominance filter suppression determining unit 123, the chrominance filter inhibiting mode specifying unit 124, and the reference restriction specifying unit 125, and the SAO processing unit 109 and the motion estimator 111 are described below in detail.

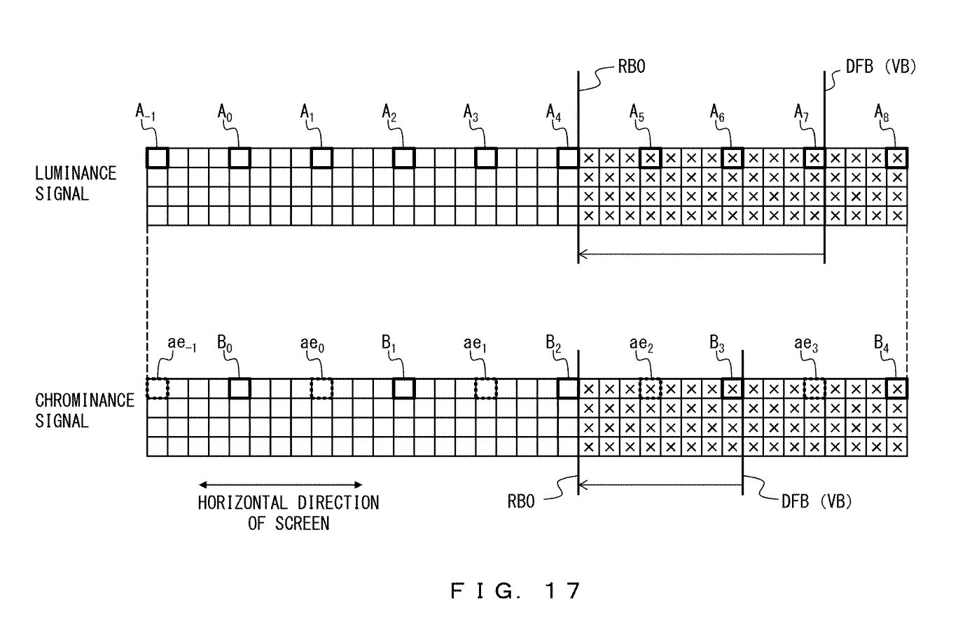

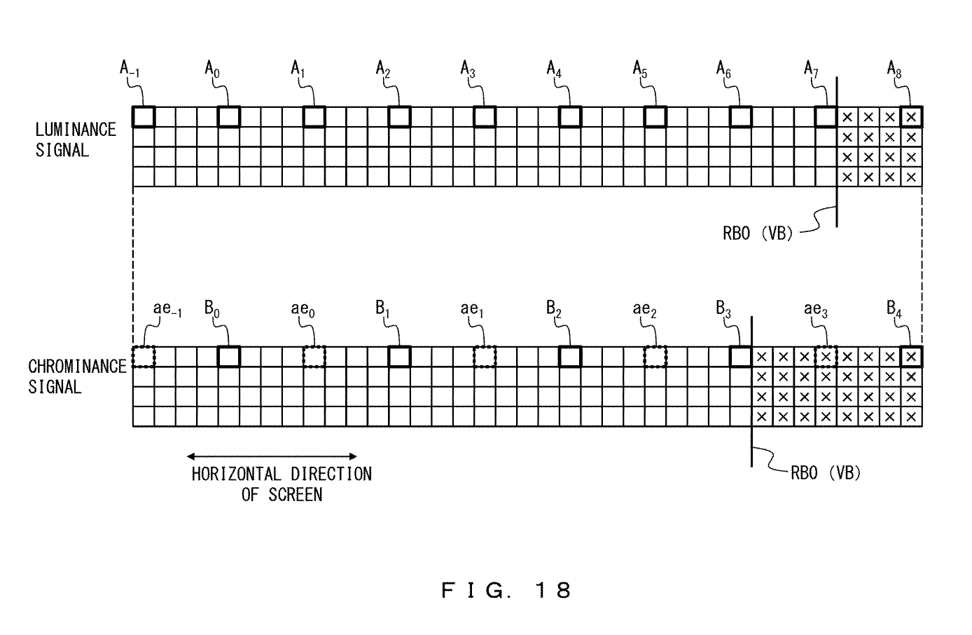

First, a process of calculating a position of a reference restriction boundary RBO before the SAO processing performed by the boundary position calculator 121 is described with reference to FIGS. 17 and 18.

FIG. 17 illustrates a position of a reference restriction boundary before the SAO processing when the DF processing is enabled. FIG. 18 illustrates a position of a reference restriction boundary before the SAO processing when the DF processing is disabled.

A square marked with “x” in FIGS. 17 and 18 represents that a pixel value that corresponds to the position of the square is inhibited from being referenced. The Aₖ in FIGS. 17 and 18 represents a pixel value of a luminance signal of integer pixel accuracy, but the expression “pixel Aₖ” or “integer pixel Aₖ” is also used in the description below. The Bₖ in FIGS. 17 and 18 represents a pixel value of a chrominance signal of integer pixel accuracy, but the expression “pixel Bₖ” or “integer pixel Bₖ” is also used in the description below. The subscript k of the pixel values Aₖ and Bₖ represents an index indicating a coordinate of a pixel in a horizontal direction. The luminance signal and the chrominance signal are managed by using coordinates with a left-hand end of a picture as a reference. When image formats of the luminance signal and the chrominance signal are 4:2:0, pixels are configured from a sampling position in the 4:2:0 format, and therefore the luminance signal and the chrominance signal can be managed by using only relative coordinates. When the image formats are 4:2:0, one integer pixel in the chrominance signal corresponds to two integer pixels in the luminance signal, as illustrated in FIG. 17.

In encoding of a moving image in the intra-refresh, a vector restriction boundary VB is an encoded block boundary, and the vector restriction boundary VB is expressed by coordinates of an encoded block unit or coordinates of a pixel, for example, with a left-hand end of a picture specified as 0. In FIG. 17, a vector restriction boundary VB of a luminance signal is illustrated by a horizontal pixel index A₇. In FIG. 17, a vector restriction boundary VB of a chrominance signal is illustrated by a horizontal pixel index B₃.

The vector restriction boundary VB indicates a boundary between a referable area and a reference inhibiting area sandwiching an encoded block boundary (namely, a reference restriction boundary RB) on a current picture to be encoded. In the example illustrated in FIG. 17, an area on a left-hand side of the vector restriction boundary VB is a referable area, similarly to the intra-refresh illustrated in FIGS. 2 and 3.

When the DF processing is enabled, the vector restriction boundary VB matches a DF boundary DFB. Accordingly, the vector restriction boundary VB in FIG. 17 is the encoded block boundary, and is also the DF boundary DFB. Because the encoded block boundary is the DF boundary DFB, the boundary position calculator 121 calculates the number of pixels from the vector restriction boundary VB in the referable area that are rewritten in the DF processing by referencing the reference inhibition area. At this time, the boundary position calculator 121 determines whether the DF processing is performed, namely, whether the DF processing is enabled, on the basis of a value of a syntax element “slice_deblocking_filter_disabled_flag”.

When the DF processing is enabled (slice_deblocking_filter_disabled_flag=0), with respect to a luminance signal, data of 4 pixels at most from the DF boundary DFB are referenced, and data of 3 pixels may be changed as a result of filtering. Accordingly, a position of a reference restriction boundary RBO of the luminance signal after the DF processing and before the SAO processing is a pixel A₄ that is located 3 pixels in a leftward direction of a pixel A₇. Similarly, with respect to a chrominance signal, data of 2 pixels from the DF boundary DFB are referenced, and data of 1 pixel may be changed as a result of filtering. Accordingly, a position of a reference restriction boundary RBO in a chrominance signal after the DF processing and before the SAO processing is a pixel B₂ that is located 1 pixel in a leftward direction of a pixel B₃. When an image format is 4:2:0 or 4:2:2, a position of a reference restriction boundary RB of the chrominance signal after the DF processing is shifted in a leftward direction by 2 pixels in the luminance signal, as illustrated in FIG. 17.

When the DF processing is disabled (slice_deblocking_filter_disabled_flag=1), a position of a reference restriction boundary RBO of a luminance signal before the SAO processing is the same as that of a vector restriction boundary VB indicated by a horizontal pixel index A₇, as illustrated in FIG. 18. When the DF processing is disabled, a position of a reference restriction boundary RBO of a chrominance signal before the SAO processing is the same as that of a vector restriction boundary VB indicated by a horizontal pixel index B₃, as illustrated in FIG. 18.

The position of the reference restriction boundary RBO before the SAO processing of a current picture to be encoded that has been calculated by the boundary position calculator 121, as described above, is output to the chrominance filter inhibiting mode specifying unit 124, and is also output to (stored in) the boundary position storing unit 122. The position of the reference restriction boundary RBO of the current picture to be encoded that has been stored in the boundary position storing unit 122 influences a position of the reference restriction boundary RB when a decoded image of the current picture to be encoded is used as a reference picture in motion estimation on a subsequent picture. Therefore, the moving image encoder 1 stores the position of the reference restriction boundary RBO of the current picture to be encoded in the boundary position storing unit 122 until the decoded image of the current picture to be encoded is no longer referenced.

The reference restriction type calculated by the boundary position calculator 121 is described next.

FIGS. 17 and 18 illustrate a reference restriction boundary RB in the intra-refresh illustrated in FIG. 2, namely, when a refresh area (the vector restriction boundary VB) is shifted in a leftward direction for each picture such that the vector restriction boundary VB is shifted from a left-hand end to a right-hand end of the picture in a certain cycle. However, there are the following four types of the reference restriction boundary RB due to a relationship between the referable area and the reference inhibition area.

Type 0: An area on a left-hand side of the reference restriction boundary RB is a referable area, and an area on a right-hand side of the reference restriction boundary RB is a reference inhibition area.

Type 1: An area on a right-hand side of the reference restriction boundary RB is a referable area, and an area on a left-hand side of the reference restriction boundary RB is a reference inhibition area.

Type 2: An area on an upper side of the reference restriction boundary RB is a referable area, and an area on a lower side of the reference restriction boundary RB is a reference inhibition area.

Type 3: An area on a lower side of the reference restriction boundary RB is a referable area, and an area on an upper side of the reference restriction boundary RB is a reference inhibition area.

A case can be considered in which the reference restriction boundary RB is rectangular (two-dimensional), as described below, but a relationship between the referable area and the reference inhibition area in a corner of a rectangle can be calculated from a combination of two of the four types. Accordingly, in the embodiment, it is assumed that the reference restriction boundary RB is a boundary line (one-dimensional), for simplicity. Hereinafter, Type 0 to Type 4 of the reference restriction boundary RB are referred to as reference restriction types.

A determining process performed by the chrominance filter suppression determining unit 123 is described next.

The chrominance filter suppression determining unit 123 determines whether a chrominance filter mode of the SAO processing is suppressed on the basis of a relationship between the reference restriction type above and an image format. The image format is specified on the basis of a syntax element “chroma_format_idc”.

As illustrated in FIGS. 17 and 18, when a boundary line is located in a vertical direction with a position of the reference restriction boundary RB as a reference, an area on a left-hand side of the boundary line is a referable area, and an area on a right-hand side of the boundary line is a reference inhibition area, reference is restricted in a horizontal direction. A horizontal coordinate of a chrominance is the same in the image formats 4:2:2 and 4:2:0. Therefore, when the reference restriction boundary RB is a boundary line in a vertical direction, the 4:2:2 format and the 4:2:0 format can be handled similarly.

However, the intra-refresh includes a scheme (type) in which the refresh boundary B is shifted from an upper end to a lower end of a picture and a scheme (type) in which the refresh boundary B is shifted from the lower end to the upper end of the picture. In these schemes, pixel accuracy of a vertical coordinate of a chrominance is different in the image formats 4:2:2 and 4:2:0, and the 4:2:2 format does not have a problem wherein a motion vector fails to be calculated, as described above. Accordingly, in the 4:2:2 format, when the reference restriction boundary RB is a boundary line in a horizontal direction, a chrominance filter mode of the SAO processing does not need to be suppressed. Therefore, as an example, in the 4:2:0 format, the chrominance filter suppression determining unit 123 determines that the chrominance filter mode of the SAO processing is suppressed in all of the types. In the 4:2:2 format, the chrominance filter suppression determining unit 123 determines that the chrominance filer mode is suppressed in Types 0 and 1, and that the chrominance filer mode is not suppressed in Types 2 and 3.

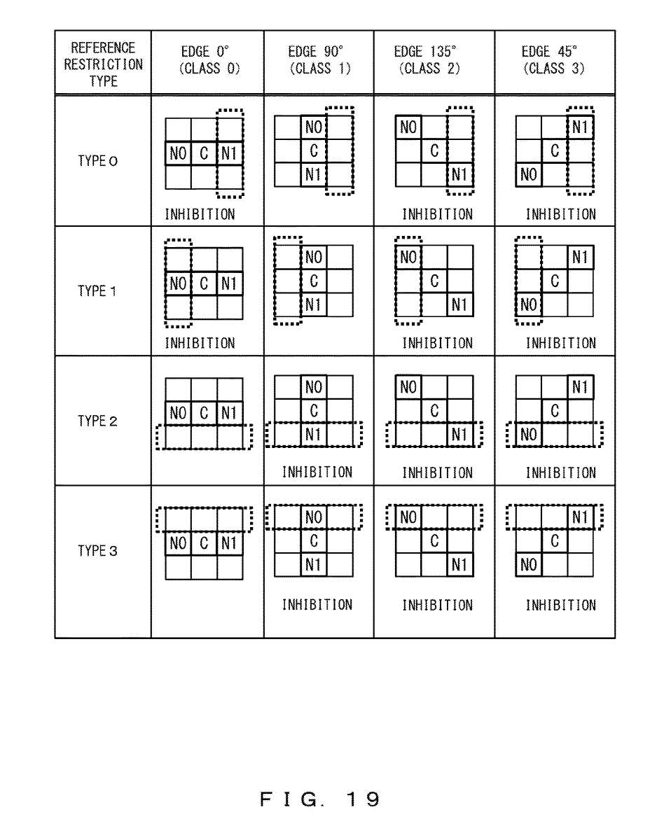

A process performed by the chrominance filter inhibiting mode specifying unit 124 is described next with reference to FIG. 19.

The chrominance filter inhibiting mode specifying unit 124 determines whether at least the reference restriction boundary RB is included, or which area from a target encoded block that is adjacent across the reference restriction boundary RB is the reference inhibition area on the basis of the reference restriction type, and calculates a color difference filter inhibiting mode.

FIG. 19 illustrates a relationship between the reference restriction type and the chrominance filter inhibiting mode. FIG. 19 illustrates a relationship between a pixel C to which an offset is applied and the reference inhibition area for each of the reference restriction types in four classes of an edge offset type in the SAO processing. The reference inhibition area is illustrated with a thick dotted line.

The chrominance filter inhibiting mode specifying unit 124 specifies a class that includes an adjacent pixel NO or N1 in the reference inhibition area to be the chrominance filter inhibiting mode. As an example, when the reference restriction type is Type 0, Edge0° (class 0), Edge135° (class 2), and Edge45° (class 3) are the chrominance filter inhibiting modes.

Here, in an encoded block that is a target for calculation of the chrominance mode inhibiting mode, a chrominance SAO mode can be set by using syntax elements “sao_type_idx_chroma” and “sao_eo_class_chroma”. In the color difference filter inhibiting mode, not only a class that includes an adjacent pixel N0 or N1 in the reference inhibition area but also, for example, all of the edge offset types may be inhibited, or all types other than the None type may be inhibited. Further, by selecting the same mode as an adjacent encoding mode by using syntax elements “sao_merge_left_flag” and “sao_merge_up_flag”, the number of bits needed for a bit syntax can be reduced, but as a result of this, the chrominance filter inhibiting mode does not need to be selected. The encoded block that is a target for calculation of the chrominance mode inhibiting mode may be all of the encoded blocks in a certain area (a slice or a picture) that includes an encoded block including the reference restriction boundary

RB. In the slice, all of the chrominance filter modes may be inhibited by using a syntax element “slice_sao_chroma_flag”.

A process performed by the SAO processing unit 109 is described next.

The SAO processing unit 109 performs the SAO processing on an image after the DF processing when the DF processing is enabled, and performs the SAO processing on an image generated by the decoded image generator 107 when the DF processing is disabled. The SAO processing unit 109 selects an optimum mode from among modes other than the chrominance filter inhibiting mode specified by the chrominance filter inhibiting mode specifying unit 124, and adds or subtracts an offset value specified according to the selected mode to/from a pixel C to be processed. As an example, when the reference restriction type is Type 0, an optimum mode is selected from among an edge offset, a band offset, and None of Edge90° that is a mode other than Edge0°, Edge135°, and Edge45° that are the chrominance filter inhibiting modes. A mode can be selected in any known selecting method. As an example, a mode that has a minimum value in a Rate-Distortion calculation expression expressed by Expression (11).

SAOCost=Distortion+λ*BitCost (11)

In Expression (11), the Distortion represents an error of a pixel between an original image and a pixel after the SAO processing in a certain mode. The Distortion is calculated, for example, by using an SAD (a pixel difference absolute value sum), an MSE (a mean square error), or the like. The BitCost represents the number of bits needed for a syntax for encoding in a certain mode, and the λ represents a constant for adjusting a balance between Distortion and BitCost.

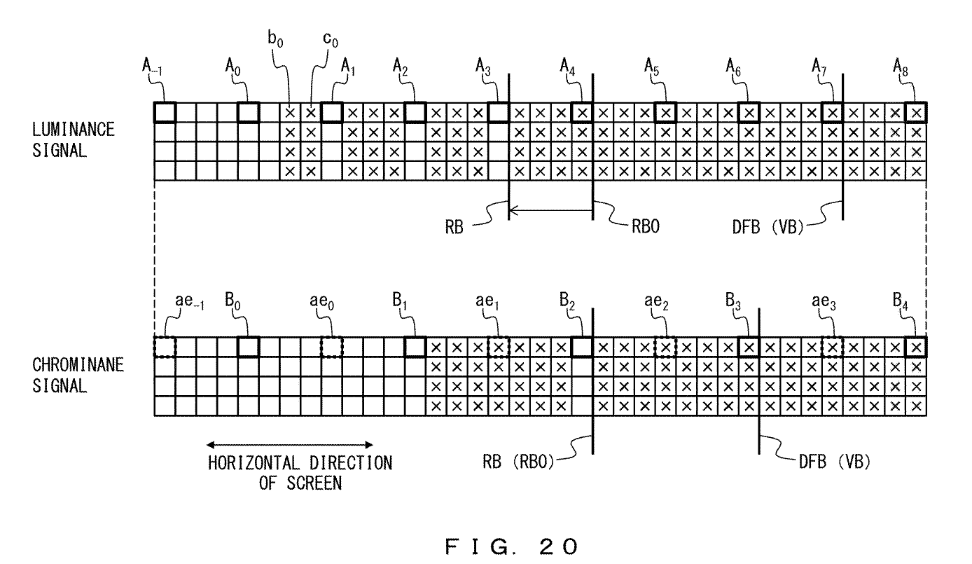

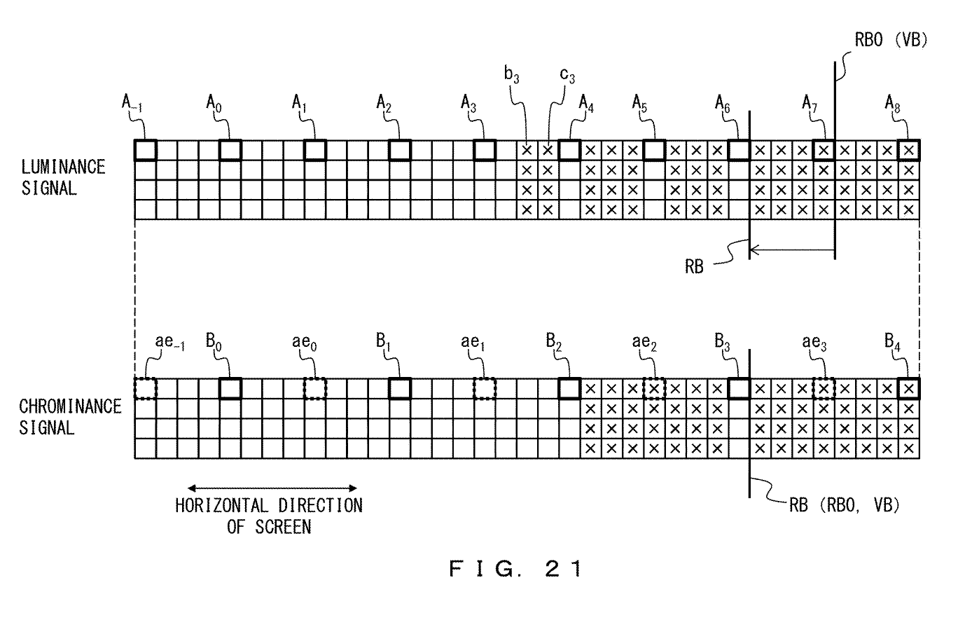

A process performed by the reference restriction specifying unit 125 is described next with reference to FIGS. 20 and 21.

FIG. 20 illustrates a position of a reference restriction boundary after the SAO processing when the DF processing is enabled according to the embodiment. FIG. 21 illustrates a position of a reference restriction boundary after the SAO processing when the DF processing is disabled according to the embodiment. A square marked with “x” in FIGS. 20 and 21 represents that a pixel value that corresponds to the position of the square is inhibited from being referenced.

The reference restriction specifying unit 125 calculates a final position of a reference restriction boundary RB on the basis of a position of the reference restriction boundary RB after the SAO processing.

The SAO processing on a luminance signal in the moving image encoder 1 according to the embodiment is the same as the processing in the moving image encoder 100 of FIG. 1. Therefore, in a case in which the DF processing is enabled, when a DF boundary DFB of a luminance signal is located in a position of a pixel A₇, as illustrated in FIG. 20, a position of a reference restriction boundary RBO after the DF processing and before the SAO processing is a position of a pixel A₄ that has been shifted 3 pixels in a leftward direction of the DF boundary (the pixel A₇). A position of the reference restriction boundary RB after the SAO processing is a position of a pixel A₃ that has been shifted 1 pixel in a leftward direction of the pixel A₄. Further, when reference restriction due to motion compensation is calculated, a relationship between the referable area and the reference inhibition area of a luminance signal is as illustrated in FIG. 20.

A DF boundary DFB of a chrominance signal is located in a position of a pixel B₃, as illustrated in FIG. 20, and a position of a reference restriction boundary RBO after the DF processing and before the SAO processing is a position of a pixel B₂ that has been shifted 1 pixel in a leftward direction of the pixel B₃.

The moving image encoder 1 according to the embodiment specifies the chrominance filter inhibiting mode on the basis of the reference restriction type, the image format, and the like, and performs the SAO processing on the chrominance signal in a mode other than the chrominance filter inhibiting mode, as described above. When the reference restriction type is Type 0, as illustrated in FIGS. 17 and 20, in the SAO processing on the chrominance signal, an optimum mode is selected from among the edge offset, the band offset, and None in class 1) (Edge90°). Therefore, in the SAO processing on the chrominance signal, an area on a right-hand side of a pixel C to be processed is not referenced. Stated another way, in the SAO processing on the chrominance signal, when offset processing is performed on a pixel B₂ that is adjacent to the reference restriction boundary RBO before the SAO processing as a pixel C, an area on a right-hand side of the reference restriction boundary RBO is not referenced. Accordingly, a position of the reference restriction boundary RB after the SAO processing is the same as a position of the reference restriction boundary RBO after the DF processing and before the SAO processing, as illustrated in FIG. 20. When reference restriction on a chrominance signal due to motion compensation is calculated on the basis of the position of the reference restriction boundary RB after the SAO processing, a referable area of the chrominance signal is as illustrated in FIG. 20.

When the DF processing is disabled, a position of a reference restriction boundary RB of a luminance signal before the SAO processing is a position of the pixel A₇, which is the same as the position of the vector restriction boundary VB, as illustrated in FIG. 21. Accordingly, a position of the reference restriction boundary RB after the SAO processing is a position of a pixel A₆ that has been shifted 1 pixel in a leftward direction of the position (the pixel A₇) of the reference restriction boundary RB before the SAO processing. When the DF processing is disabled, a position of the reference restriction boundary RB of a chrominance signal before the SAO processing is apposition of the pixel B₃, which is the same as the position of the vector restriction boundary VB, as illustrated in FIG. 21. When the reference restriction type is Type 0, a position of the reference restriction boundary RB of a chrominance signal after the SAO processing is the same as the position of the reference restriction boundary RB before the SAO processing. Accordingly, in a case in which the DF processing is disabled, when reference restriction on a luminance signal and a chrominance signal due to motion compensation is calculated on the basis of a reference restriction position after the SAO processing, respective referable areas are as illustrated in FIG. 21.

When FIG. 20 is compared with FIG. 10, a referable area of a luminance signal is the same, but a reference inhibition area of a chrominance signal in the embodiment is smaller than the reference inhibition area illustrated in FIG. 10. Similarly, when FIG. 21 is compared with FIG. 13, a referable area of a luminance signal is the same, but a reference inhibition area of a chrominance signal in the embodiment is smaller than the reference inhibition area illustrated in FIG. 13. Namely, according to the embodiment, extension of a reference inhibition area of a chrominance signal can be suppressed.

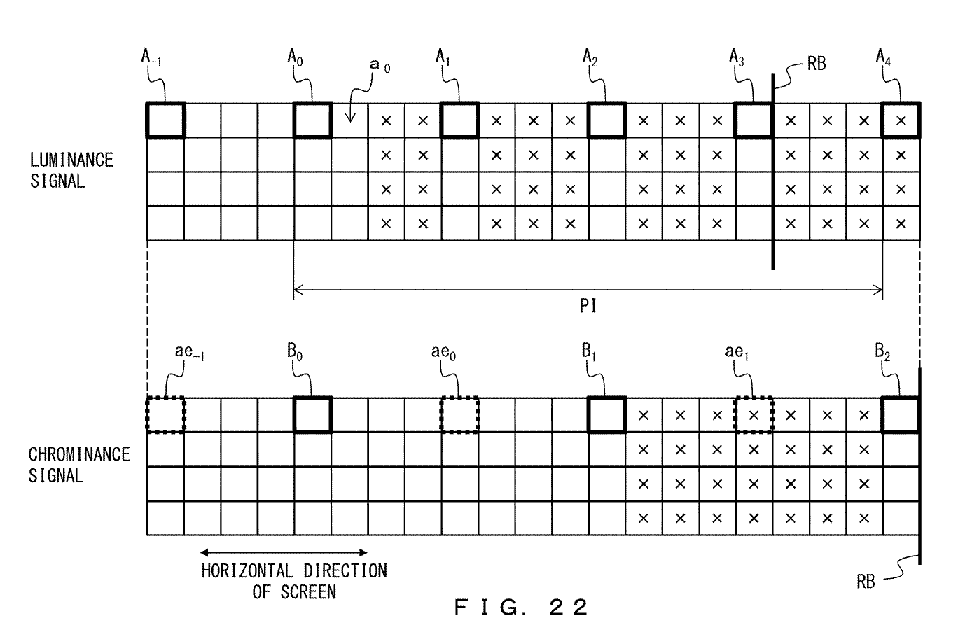

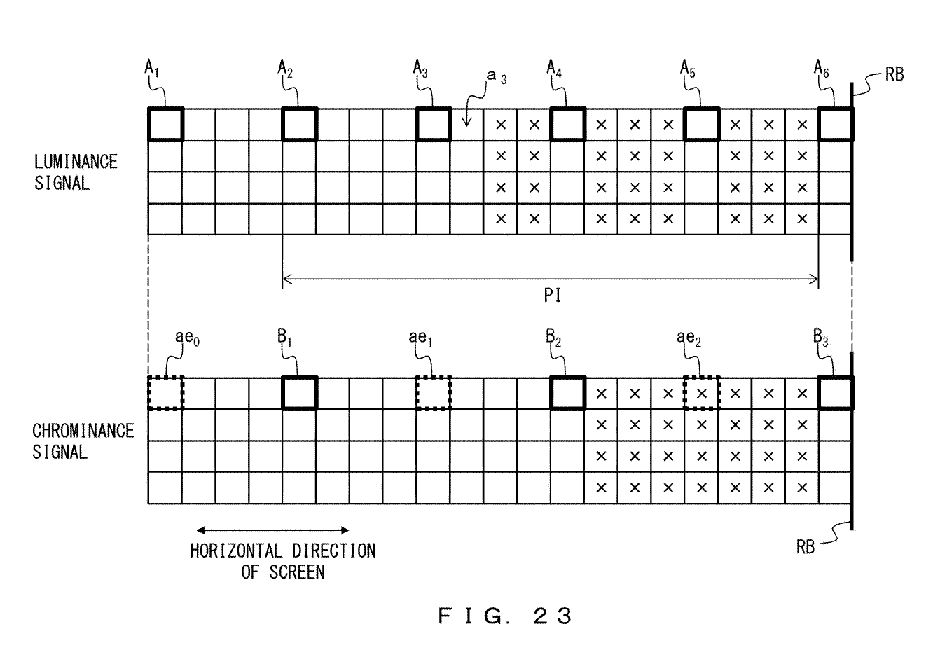

Whether a prediction image can be generated on the basis of a referable area in the embodiment illustrated in FIGS. 20 and 21 is described next with reference to FIGS. 22 and 23.

FIG. 22 is a diagram explaining whether a prediction image can be generated when the DF processing and the SAO processing are enabled according to the embodiment. FIG. 23 is a diagram explaining whether a prediction image can be generated when the DF processing is disabled and the SAO processing is enabled according to the embodiment. A square marked with “x” in FIGS. 22 and 23 represents that a pixel value that corresponds to the position of the square is inhibited from being referenced.

As described above, in a luminance signal, a prediction image is configured of pixels having the same accuracy with a pixel in a left-upper-end position as a reference. The size of the prediction image is the same as the size of an inter-prediction block, but in encoding in the 4:2:0 format, a prediction image needs to conform to the 4:2:0 format.

Namely, all of the prediction images on a reference image can be configured in the 4:2:0 format. At this time, a luminance signal and a chrominance signal do not always have pixels of the same accuracy. Whether a prediction image in the 4:2:0 format can be generated when the DF processing and the SAO processing are enabled is described here. For simplicity, it is assumed that a prediction image has, for example, the size of 4 pixels in a horizontal direction. In FIG. 22, a case is considered in which an integer pixel A₀ is located in a left-upper-end position of a prediction image PI, and the prediction image of a luminance signal is configured of integer pixels from the pixel A₀ to a pixel A₃. In this case, in order to generate a prediction image in the 4:2:0 format, a prediction image of a chrominance signal needs to be configured of integer pixels B₀ and B₁. Both of the integer pixels B₀ and B₁ of the chrominance signal are referable, as illustrated in FIG. 22. Accordingly, when a prediction image of a luminance signal is configured of the integer pixels from pixels A₀ to A₃, a prediction image in the 4:2:0 format can be generated.

In FIG. 22, in a case in which an integer pixel A₋₁ is located in an left-upper-end position of a prediction image, and the prediction image of a luminance signal is configured of integer pixels from the pixel A₋₁ to a pixel A₂, a prediction image of a chrominance signal needs to be configured of integer pixels ae₋₁ and ae₀ in the 4:2:0 format. In the embodiment, as illustrated in FIG. 22, both of the integer pixels ae₋₁ and ae₀ of the chrominance signal are referable. Namely, in the embodiment, extension of an area that fails to be referenced due to the SAO processing and motion compensation is suppressed, and the pixel ae₀ that is inhibited from being referenced in the example illustrated in FIG. 17 is also referable. Thus, according to the embodiment, also in a case in which a prediction image of a chrominance signal is configured of the integer pixels from the pixel A₋₁ to the pixel A₂, a prediction image in the 4:2:0 format can be generated.

This applies to a referable area illustrated in FIG. 23 when the DF processing is disabled. As an example, in the example illustrated in FIG. 14 relating to a case in which the DF processing is disabled, ae₁ of a chrominance signal is inhibited from being referenced. Therefore, in the example illustrated in FIG. 14, a prediction image of a luminance signal that has an integer pixel A₁ in a left-upper-end position fails to be configured of integer pixels A₁ to A₄. In contrast, according to a process result in the embodiment illustrated in FIG. 23, the integer pixel ae₁ is referable. Accordingly, a prediction image of a luminance signal can be configured of integer pixels from the pixel A₁ to the pixel A₄.

The motion estimator 111 hierarchically performs motion estimation on an inter-prediction block. Namely, the motion estimator 111 detects the best motion vector by using integer pixels, and then performs decimal pixel estimation in a peripheral area. Consequently, a calculation amount in estimation is reduced. Due to this characteristic, it is more convenient that a reference restriction position is indicated while integer pixels are separated from decimal pixels. Accordingly, with respect to a final reference restriction position RB based on a luminance signal on a reference picture, all integer pixels in a leftward direction of an integer pixel A₃ and all decimal pixels in a leftward direction of a decimal pixel a₀ are referable, when the DF processing is enabled. Similarly, when the DF processing is disabled, all integer pixels in a leftward direction of an integer pixel A₅ and all decimal pixels in a leftward direction of a decimal pixel a₃ are referable. The motion estimator 111 calculates a motion vector on the basis of the above position of the reference restriction boundary RB by using only a referable area. Accordingly, by suppressing reduction in a referable area of a chrominance signal, a larger number of prediction images can be generated, and a more appropriate prediction image (motion vector) can be obtained.

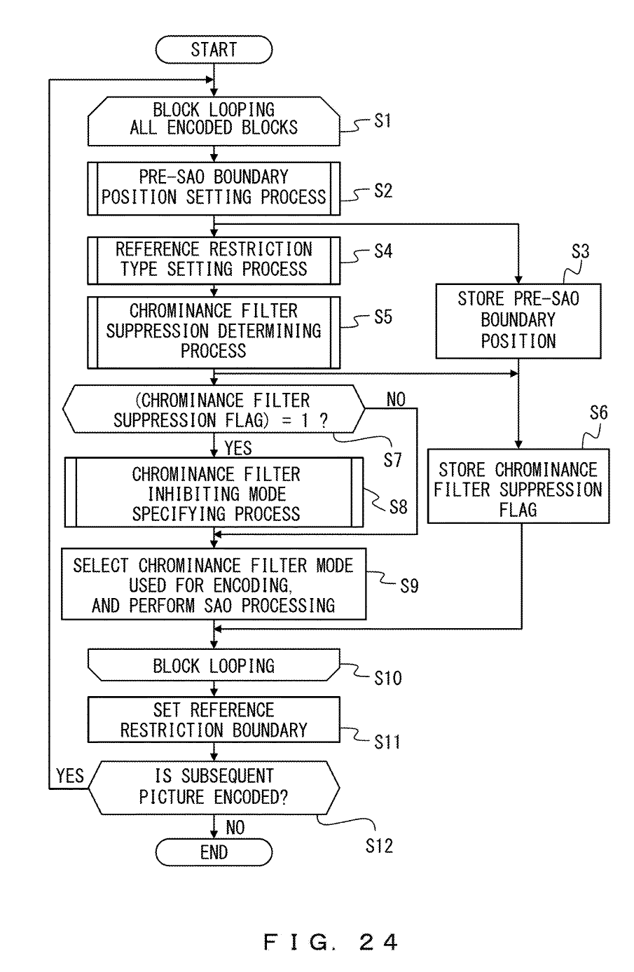

The processing above performed by the moving image encoder 1 according to the embodiment is described again with reference to the flowcharts of FIGS. 24 to 28. The motion estimator 111 independently calculates a motion vector on the basis of a position of a vector restriction boundary VB of a current picture to be encoded and a position of a reference restriction boundary RB of a reference picture by using only a referable area of the reference picture in a vector restriction target block, although this is not illustrated in FIGS. 24 to 28. The encoder 150 in the moving image encoder performs motion compensation and the generation of a prediction image on the basis of the motion vector derived by the motion estimator 111, and then encodes a picture to be encoded in a procedure similar to that of the moving image encoder 100 illustrated in FIG. 1 and recovers a reference picture used to encode a subsequent picture. The moving image encoder 1 performs processing illustrated in FIG. 24 on all of the encoded blocks of the current picture to be encoded in parallel to derivation of a motion vector and encoding of a picture as described above so as to specify a position of a reference restriction boundary RB in the current picture to be encoded.

FIG. 24 is a flowchart illustrating a procedure of a reference restriction controlling process in moving image encoding according to the embodiment.

When a block loop process performed on all of the encoded blocks in a current picture to be encoded is started (step Si), the moving image encoder 1 first performs a pre-SAO boundary position setting process (step S2). The process of step S2 is performed by the boundary position calculator 121. The boundary position calculator 121 calculates a position of a reference restriction boundary RBO before the SAO processing on a reference picture on the basis of a position of a vector restriction boundary VB of the current picture to be encoded and the existence of the DF processing.

When the boundary position calculator 121 calculates the position of the reference restriction boundary RBO, the boundary position calculator 121 stores the calculated position of the reference restriction boundary RBO as a pre-SAO boundary position in the boundary position storing unit 122 (step S3). When the boundary position calculator 121 calculates the position of the reference restriction boundary RBO, the boundary position calculator 121 performs a reference restriction type setting process (step S4). In step S4, the boundary position calculator 121 sets a reference restriction type on the basis of a combination of a referable area and a reference inhibition area with the calculated position of the reference restriction boundary RBO as a reference. When the reference restriction boundary RBO is rectangular, a plurality of reference restriction types may be selected in step S4.

When the boundary position calculator 121 finishes the process of step S4, the moving image encoder 1 performs a chrominance filter suppression determining process (step S5). The process of step S5 is performed by the chrominance filter suppression determining unit 123. The chrominance filter suppression determining unit 123 determines whether a color filter in the SAO processing is suppressed on the basis of the reference restriction type and image format information. A determination result is set in a chrominance filter suppression flag. When a chrominance filter is suppressed, the chrominance filter suppression determining unit 123 sets a value of the chrominance filter suppression flag to 1. When a chrominance filter is not suppressed, the chrominance filter suppression determining unit 123 sets a value of the chrominance filter suppression flag to 0.

When the chrominance filter suppression determining unit 123 finishes the chrominance filter suppression determining process, the chrominance filter suppression determining unit 123 stores a determination result (the chrominance filter suppression flag) in the boundary position storing unit 122 (step S6).

When the chrominance filter suppression determining unit 123 finishes the processes of steps S5 and S6, the moving image encoder 1 checks whether the chrominance filter suppression flag is 1 (step S7). The checking in step S7 is performed by the chrominance filter inhibiting mode specifying unit 124. When the chrominance filter suppression flag is 1 (step S7; Yes), the chrominance filter inhibiting mode specifying unit 124 performs a chrominance filter inhibiting mode setting process (step S8). In step S8, the chrominance filter inhibiting mode specifying unit 124 specifies a chrominance filter inhibiting mode for inhibiting a chrominance SAO mode for referencing a pixel in a reference inhibition area on the basis of the reference restriction type, when the current block to be encoded includes a reference restriction boundary RB, or when the current block to be encoded is an adjacent encoded block. When the chrominance filter suppression flag is 0, the chrominance filter inhibiting mode specifying unit 124 does not specify the chrominance filter inhibiting mode.

When the chrominance filter inhibiting mode specifying unit 124 finishes the processes of S7 and S8, the moving image encoder 1 selects a chrominance SAO mode used for encoding, and performs the SAO processing (step S9). The process of step S9 is performed by the SAO processing unit 109. The SAO processing unit 109 selects a chrominance SAO mode used for encoding from among chrominance SAO modes other than the chrominance filter inhibiting mode on the basis of the chrominance filter inhibiting mode specified by the chrominance filter inhibiting mode specifying unit 124. When the DF processing is enabled, the SAO processing unit 109 also performs the SAO processing on a luminance signal and the SAO processing in the selected chrominance SAO mode on an image after the DF processing. When the DF processing is disabled, the SAO processing unit 109 performs the SAO processing on a luminance signal and the SAO processing in the selected chrominance SAO mode on a decoded image generated by the decoded image generator 107. Further, the SAO processing unit 109 stores the decoded image on which the SAO processing has been performed in the decoded image storing unit 110.

When the SAO processing unit 109 finishes the process of step S9, the moving image encoder 1 checks whether the processes of steps S2 to S9 have been performed on all of the encoded blocks in the current picture to be encoded. The moving image encoder 1 repeats processing until the processes of steps S2 to S9 have been performed on all of the encoded blocks (step S10).

When the processes of steps S2 to S9 have been performed on all of the encoded blocks, the moving image encoder 1 calculates and sets a final reference restriction boundary of a luminance signal after the SAO processing, for example, on the basis of the position of the reference restriction boundary RBO before the SAO processing and the chrominance filter suppression flag that have been stored in the boundary position storing unit 122 (step S11). The process of step S11 is performed by the reference restriction specifying unit 125. The reference restriction specifying unit 125 calculates a final position of the reference restriction boundary RB of the luminance signal after the SAO processing at the same time as motion estimation performed by the motion estimator 111. The process of step S11 maybe performed by the time when the current picture to be encoded is referenced by a subsequent picture.

The moving image encoder 1 determines whether a subsequent picture is encoded (step S12). When a subsequent picture is encoded (step S12; Yes), the moving image encoder 1 performs the processes of steps S2 to S9 on the subsequent picture to be encoded. When there are no pictures to be encoded (step S12; No), the moving image encoder 1 finishes encoding including the processes of steps S2 to S9.

When the current picture to be encoded is referenced in motion estimation on the subsequent picture to be encoded, the motion estimator 111 references only a referable area, and calculates a motion vector on the basis of the position of the vector restriction boundary VB on a picture to be referenced and the position of the reference restriction boundary RB that has been specified by the reference restriction specifying unit 125. The encoder 150 of the moving image encoder 1 performs motion compensation, the generation of a prediction image, and the like by using the motion vector calculated (derived) by the motion estimator 111.

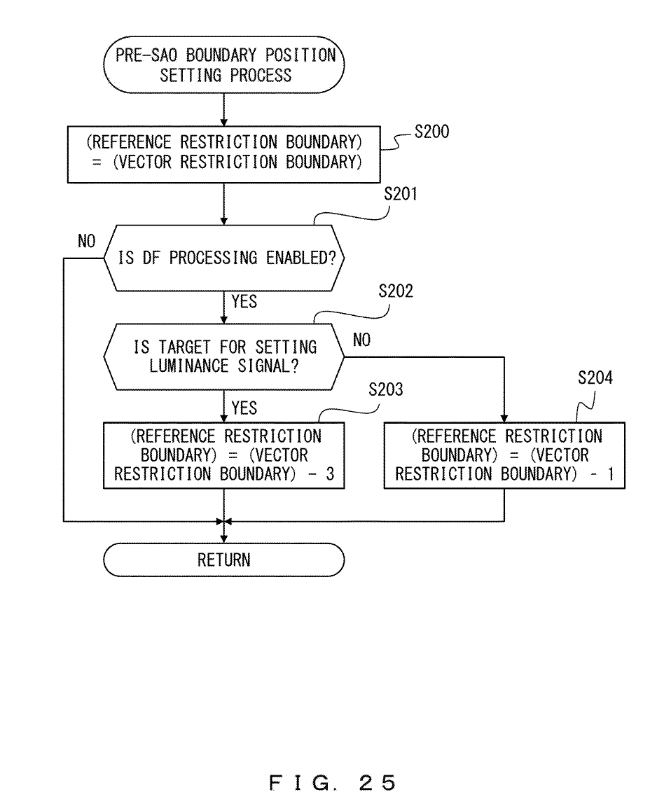

FIG. 25 is a flowchart illustrating the content of the pre-SAO boundary position setting process.

The boundary position setting unit 121 performs processing illustrated in FIG. 25 as the pre-SAO boundary position setting process illustrated in FIG. 24 (step S2). The processing illustrated in FIG. 25 is individually performed on a luminance signal and a chrominance signal.

The boundary position setting unit 121 first sets the position of the vector restriction boundary VB of the current picture to be encoded to be a reference restriction boundary RB before the SAO processing (step S200).

The boundary position setting unit 121 determines whether the DF processing is enabled (step S201). In step S201, the boundary position setting unit 121 determines whether the DF processing is enabled on the basis of a value of a syntax element “slice_deblocking_filter_disabled_flag”. When the DF processing is enabled (step S201; No), the boundary position setting unit 121 finishes the pre-SAO boundary position setting process (return). In this case, boundary positions before the SAO processing (positions of the reference restriction boundary RBO) of the luminance signal and the chrominance signal are positions of the vector restriction boundary VB of the respective signals.

When the DF processing is enabled (step S201; Yes), the boundary position setting unit 121 determines whether a target for setting is a luminance signal (step S202). When the target for setting is a luminance signal (step S202; Yes), the boundary position setting unit 121 changes the position of the reference restriction boundary RB from the position of the vector restriction boundary VB to a position that is reduced by 3 pixels (step S203), and finishes the pre-SAO boundary position setting process. When a target for setting is not a luminance signal, namely, when a target for setting is a chrominance signal (step S202; No), the boundary position setting unit 121 changes the position of the reference restriction boundary RB from the position of the vector restriction boundary VB to a position that is reduced by 1 pixel (step S204), and finishes the pre-SAO boundary position setting process. The position that is reduced by 3 pixels in step S203 and the position that is reduced by 1 pixel in step S204 respectively mean that the reference restriction boundary RB is shifted in a direction in which the reference inhibition area increases by 3 pixels and 1 pixel. As an example, when an area on a right-hand side of the vector restriction boundary VB is the reference inhibition area, the reference restriction boundary RB is shifted in a direction in which the reference inhibition area increases, namely, in a leftward direction in steps S203 and S204.

When the above processes of steps S200 to S204 are individually performed on the luminance signal and the chrominance signal of the current block to be encoded so as to set the reference restriction boundary, the pre-SAO boundary position setting process is finished. The processes of steps S200 to S204 on the luminance signal and the processes of steps S200 to S204 on the chrominance signal may be performed in an arbitrary order, or may be performed in parallel. The reference restriction boundary RB is shifted by 3 pixels in step S203, and by 1 pixel instep S204, but the number of pixels by which the reference restriction boundary RB is shifted may be set according to the number of pixels that has a possibility that a pixel value is changed in the DF processing.

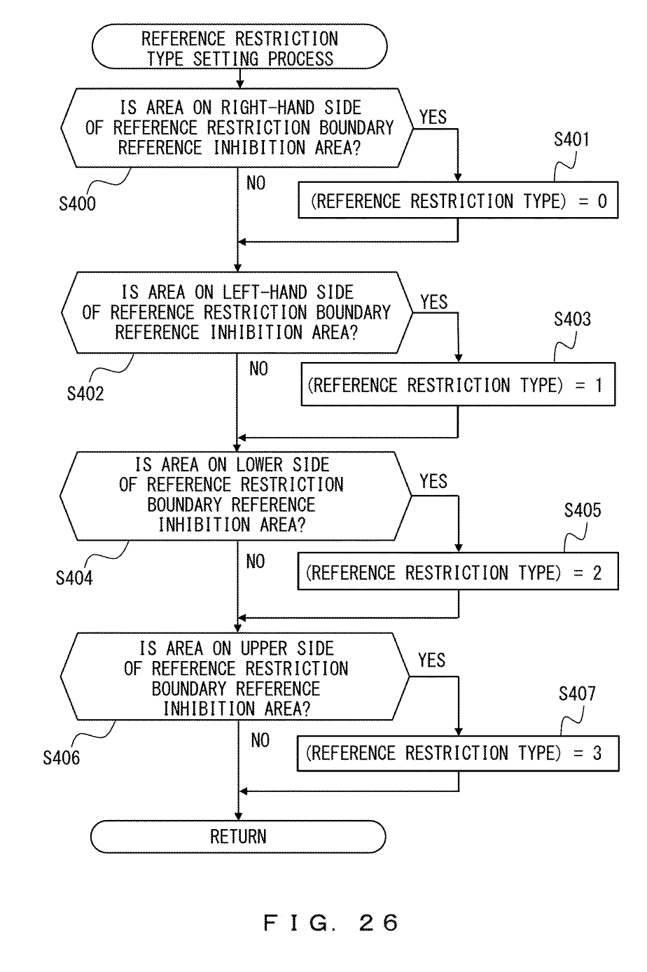

FIG. 26 is a flowchart illustrating the content of the reference restriction type setting process.

When the boundary position calculator 121 finishes the pre-SAO boundary position setting process illustrated in FIG. 24, the boundary position calculator 121 stores the set position of the reference restriction boundary RB in the boundary position storing unit 122, and performs the reference restriction type setting process (step S4). The boundary position calculator 121 performs processing illustrated in FIG. 26 as the reference restriction type setting process.

The boundary position calculator 121 first determines whether an area on a right-hand side of the reference restriction boundary RB is a reference inhibition area on the basis of the position of the reference restriction boundary RB and a combination of a referable area and a reference inhibition area (step S400).

When an area on a right-hand side of the reference restriction boundary RB is a reference inhibition area (step S400; Yes), the boundary position calculator 121 sets a value indicating the reference restriction type to 0 (step S401). Following the setting process of step S401, the boundary position calculator 121 determines whether an area on a left-hand side of the reference restriction boundary RB is a reference inhibition area (step S402). When an area on a right-hand side of the reference restriction boundary RB is not a reference inhibition area (step S400; No), the boundary position calculator 121 skips the process of step S401, and determines whether an area on a left-hand side of the reference restriction boundary RB is a reference inhibition area (step S402).

When an area on a left-hand side of the reference restriction boundary RB is a reference inhibition area (step S402; Yes), the boundary position calculator 121 sets a value indicating the reference restriction type to 1 (step S403). Following the setting process of step S403, the boundary position calculator 121 determines whether an area on a lower side of the reference restriction boundary RB is a reference inhibition area (step S404). When an area on a left-hand side of the reference restriction boundary RB is not a reference inhibition area (step S402; No), the boundary position calculator 121 skips the process of step S403, and determines whether an area on a lower side of the reference restriction boundary RB is a reference inhibition area (step S404).

When an area on a lower side of the reference restriction boundary RB is a reference inhibition area (step S404; Yes), the boundary position calculator 121 sets a value indicating the reference restriction type to 2 (step S405). Following the setting process of step S405, the boundary position calculator 121 determines whether an area on an upper side of the reference restriction boundary RB is a reference inhibition area (step S406). When an area on a lower side of the reference restriction boundary RB is not a reference inhibition area (step S404; No), the boundary position calculator 121 skips the process of step S405, and determines whether an area on an upper side of the reference restriction boundary RB is a reference inhibition area (step S406).

When an area on an upper side of the reference restriction boundary RB is a reference inhibition area (step S406; Yes), the boundary position calculator 121 sets a value indicating the reference restriction type to 3 (step S407), and finishes the reference restriction type setting process (return). When an area on an upper side of the reference restriction boundary RB is not a reference inhibition area (step S406; No), the boundary position calculator 121 skips the process of step S407, and finishes the reference restriction type setting process.

When the reference restriction boundary RB (a refresh boundary) is a boundary line in a vertical direction, as in the intra-refresh above, and the reference restriction boundary RB is shifted from left to right in each picture, an area on a right-hand side of the reference restriction boundary RB is a reference inhibition area. Accordingly, when the reference restriction type setting process illustrated in FIG. 26 is performed, a value indicating the reference restriction type becomes 0. When the reference restriction boundary RB is rectangular, a plurality of reference restriction types may be selected in the reference restriction type setting process. As an example, when a referable area is within an area surrounded by a rectangular reference restriction boundary, areas on a right-hand side and an upper side of the reference restriction boundary RB may be a reference inhibition area in an encoded block including a corner of a rectangle. When the setting process illustrated in FIG. 26 is performed on the encoded block above, 0 and 3 are set to be a value indicating the reference restriction type.

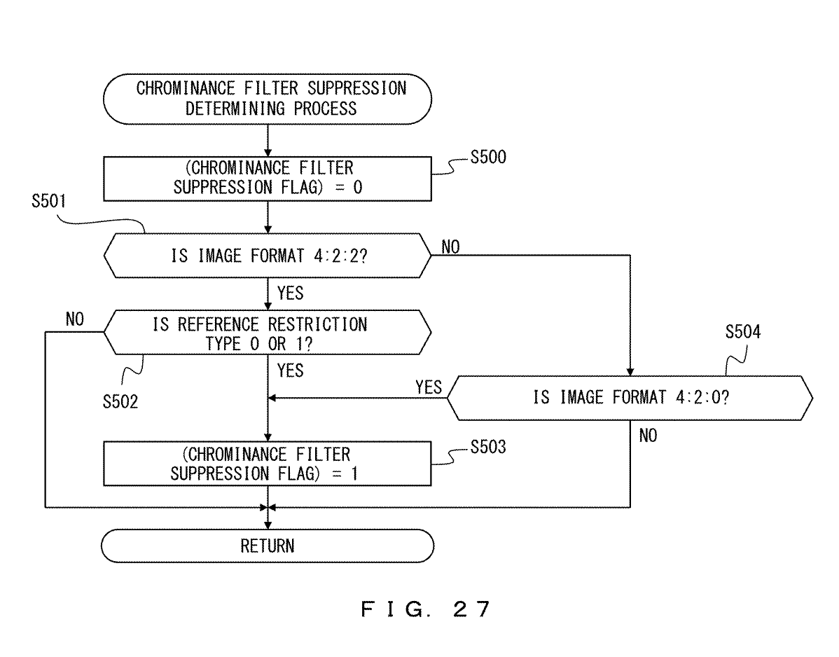

FIG. 27 is a flowchart illustrating the content of the chrominance filter suppression determining process.

The chrominance filter suppression determining unit 123 performs processing illustrated in FIG. 27 as the chrominance filter suppression determining process illustrated in FIG. 24 (step S5).

The chrominance filter suppression determining unit 123 first initiates a value of a chrominance filter suppression flag set on an encoded block to be determined to 0 (step S500). The chrominance filter suppression determining unit 123 then determines whether an image format is 4:2:2 (step S501).

When an image format is 4:2:2 (step S501; Yes), the chrominance filter suppression determining unit 123 determines whether a reference restriction type is 0 or 1 (step S502). When a reference restriction type is 0 or 1 (step S502; Yes), the chrominance filter suppression determining unit 123 changes a value of the chrominance filter suppression flag to 1 (step S503), and finishes the chrominance filter suppression determining process (return). When an image format is 4:2:2 but a reference restriction type is not 0 or 1 (step S502; No), the chrominance filter suppression determining unit 123 skips the process of step S503, and finishes the chrominance filter suppression determining process.

When an image format is not 4:2:2 (step S501; No), the chrominance filter suppression determining unit 123 determines whether an image format is 4:2:0 (step S504). When an image format is 4:2:0 (step S504; Yes), the chrominance filter suppression determining unit 123 changes a value of the chrominance filter suppression flag to 1 (step S503), and finishes the chrominance filter suppression determining process. When an image format is not 4:2:0 (step S504; No), the chrominance filter suppression determining unit 123 does not change the value of the chrominance filter suppression flag, and finishes the chrominance filter suppression determining process.

The chrominance filter suppression flag is a flag used to determine whether the chrominance filter inhibiting mode is specified by the chrominance filter inhibiting mode specifying unit 124, as described above, and when a value of the chrominance filter suppression flag is 1, the chrominance filter inhibiting mode is specified.

In a case in which an image format is 4:2:2, when the reference restriction type is 2 or 3, namely, when an area on a lower side or an upper side of the reference restriction boundary RB in a horizontal direction is a reference inhibition area, as described above, a prediction image can be generated by using integer pixels within a referable area, and a motion vector can be calculated. Accordingly, in a case in which the image format is 4:2:2, when the reference restriction type is 2 or 3, the chrominance filter inhibiting mode does not need to be specified so as to suppress reduction in the referable area. Thus, in the processing illustrated in FIG. 27, when the image format is 4:2:2, and the reference restriction type is 2 or 3, the value of the chrominance filter suppression flag becomes 0.

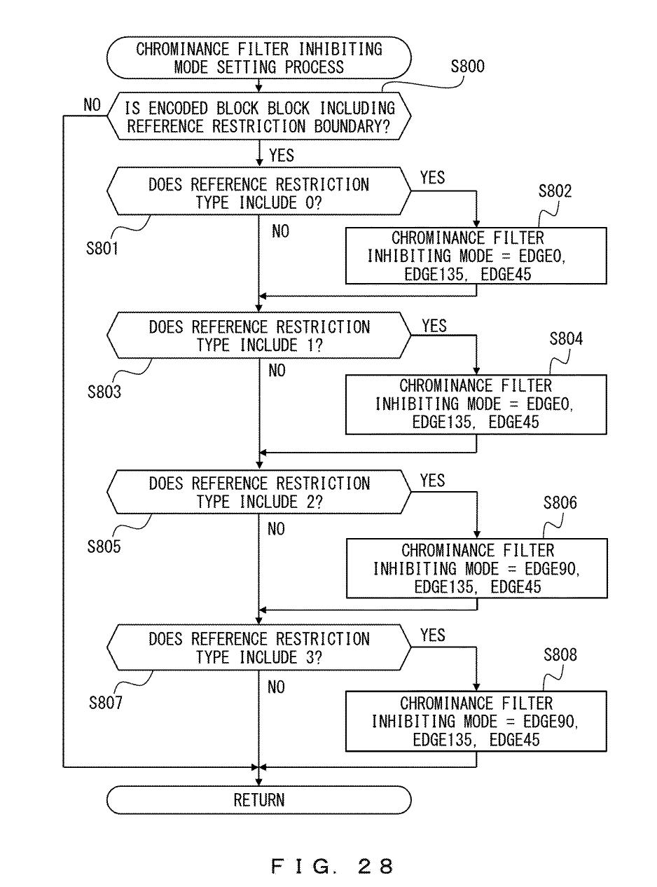

FIG. 28 is a flowchart illustrating the content of the chrominance filter inhibiting mode specifying process.

The chrominance filter inhibiting mode specifying unit 124 performs processing illustrated in FIG. 28 as the chrominance filter inhibiting mode specifying process illustrated in FIG. 24 (step S8).

The chrominance filter inhibiting mode specifying unit 124 first determines whether an encoded block to be processed is a block including the reference restriction boundary RB (step S800). In step S800, the chrominance filter inhibiting mode specifying unit 124 determines whether an encoded block is a block including the reference restriction boundary RB, for example, on the basis of a value of the chrominance filter suppression flag. When the chrominance filter inhibiting mode needs to be set, one or more values have been set in the reference restriction type in the reference restriction type setting process, and the value of the chrominance filter suppression flag has been set to 1 in the chrominance filter suppression determining process.

When a value of the chrominance filter suppression flag is 1 (step S800; Yes), the chrominance filter inhibiting mode specifying unit 124 determines whether a value set in the reference restriction type includes 0 (step S801). When the reference restriction type includes 0 (step S801; Yes), the chrominance filter inhibiting mode specifying unit 124 sets the chrominance filter inhibiting mode to Edge0 (class 0), Edge135 (class 2), and Edge45 (class 3) (step S802). Following the setting process of step S802, the chrominance filter inhibiting mode specifying unit 124 determines whether a value set in the reference restriction type includes 1 (step S803). When the reference restriction type does not include 0 (step S801; No), the chrominance filter inhibiting mode specifying unit 124 skips the process of step S802, and performs the determination of step S803.

When the reference restriction type includes 1 (step S803; Yes), the chrominance filter inhibiting mode specifying unit 124 sets the chrominance filter inhibiting mode to Edge0, Edge135, and Edge45 (step S804). Following the setting process of step S804, the chrominance filter inhibiting mode specifying unit 124 determines whether a value set in the reference restriction type includes 2 (step S805). When the reference restriction type does not include 1 (step S803; No), the chrominance filter inhibiting mode specifying unit 124 skips the process of step S804, and performs the determination of step S805.

When the reference restriction type includes 2 (step S805; Yes), the chrominance filter inhibiting mode specifying unit 124 sets the chrominance filter inhibiting mode to Edge90 (class 1), Edge135 (class 2), and Edge45 (class 3) (step S806). Following the setting process of step S806, the chrominance filter inhibiting mode specifying unit 124 determines whether a value set in the reference restriction type includes 3 (step S807). When the reference restriction type does not include (step S805; No), the chrominance filter inhibiting mode specifying unit 124 skips the process of step S806, and performs the determination of step S807.

When the reference restriction type includes 3 (step S807; Yes) the chrominance filter inhibiting mode specifying unit 124 sets the chrominance filter inhibiting mode to Edge90, Edge135, and Edge45 (step S808), and finishes the chrominance filter inhibiting mode specifying process (return). When the reference restriction type does not include 3 (step S807; No), the chrominance filter inhibiting mode specifying unit 124 skips the process of step S808, and finishes the chrominance filter inhibiting mode specifying process.

As described above, in encoding of a moving image according to the embodiment, whether the application of a filter is suppressed is determined with respect to only a chrominance signal in filtering, such as the SAO processing, that can be performed by individually setting a filter for a luminance signal and a chrominance signal. When the application of a filter to the chrominance signal is suppressed, the application of a filter for referencing data in a reference inhibition area when the filter is applied is inhibited according to a position of a reference restriction boundary RB before filtering and a position of the reference inhibition area with respect to the reference restriction boundary RB. As a result, a reference restriction boundary RB after a filter is applied to the chrominance signal is suppressed from being shifted in a direction in which a referable area is reduced. Consequently, a state in which an area that fails to be referenced is generated within the referable area when motion compensation is performed on the chrominance signal such that a motion vector fails to be calculated can be suppressed. Accordingly, the number of prediction images that can be generated and that conform to an image format can be suppressed from being reduced, and a more appropriate optimum prediction image can be generated.

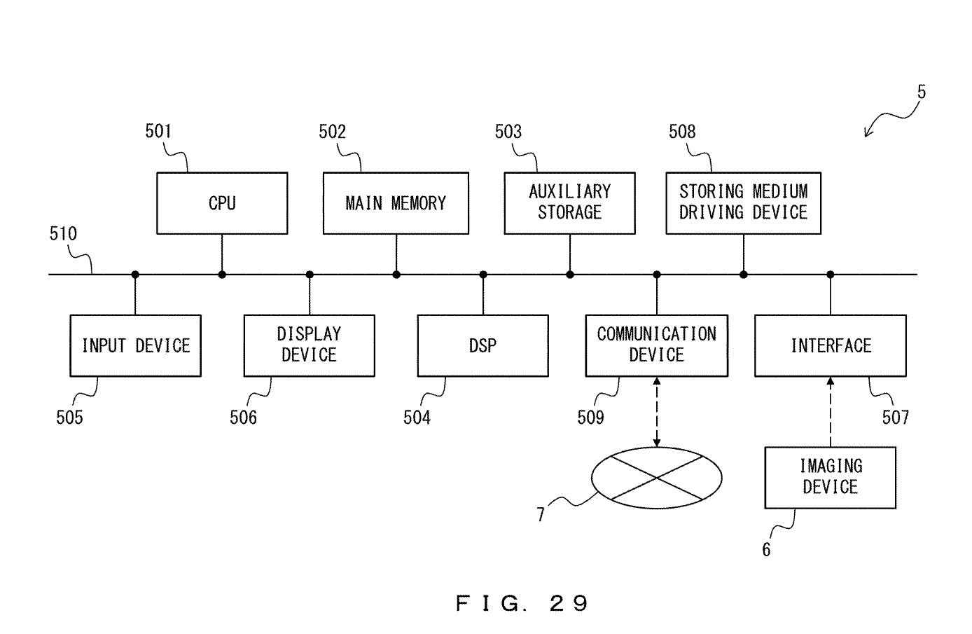

The moving image encoder 1 according to the embodiment that performs the encoding above can be implemented, for example, by a computer and a program for causing the computer to perform the encoding above. The moving image encoder 1 that is implemented by the computer and the program is described below with reference to FIG. 29.

FIG. 29 illustrates a hardware configuration of a computer.

As illustrated in FIG. 29, a computer 5 includes a Central Processing Unit (CPU) 501, a main memory 502, an auxiliary storage 503, and a Digital Signal Processor (DSP) 504. The computer 5 further includes an input device 505, a display device 506, an interface 507, a storing medium driving device 508, and a communication device 509. These components 501 to 509 in the computer 5 are mutually connected via a bus 510, and data can be received or transmitted between these components.

The CPU 501 is a processing device that controls the entire operation of the computer 5 by executing various programs including an operating system.

The main memory 502 includes a Read Only Memory (ROM) and a Random Access Memory (RAM). In the ROM, a prescribed basic control program or the like that is read by the CPU 501, for example, when the computer 5 is activated has been stored. The RAM is used as a working storage area as needed when the CPU 501 executes the various program.

The auxiliary storage 503 is a large-capacity storage, such as a Hard Disk Drive (HDD) or a Solid State Drive (SSD), compared with the main memory 502. In the auxiliary storage 503, various programs or various types of data that are executed by the CPU 501 are stored. Examples of the program stored in the auxiliary storage 503 include a program for causing a computer to perform moving image encoding including processing as illustrated in FIGS. 24 to 28 and a program for recovering or processing moving image data. Examples of data stored in the auxiliary storage 503 include data of a moving image to be encoded by the program above and encoded moving image data.

The DSP 504 is a processing device that performs encoding, decoding (reproduction), or the like of moving image data according to a control signal or the like from the CPU 501.

The input device 505 is, for example, a keyboard or a mouse. When the input device 505 is operated by an operator of the computer 5, the input device 505 transmits input information associated with the content of the operation to the CPU 501.

The display device 506 is, for example, a liquid crystal display. The liquid crystal display displays various texts, images, or the like according to display data transmitted from the CPU 501 or the like.

The interface 507 is, for example, an input/output device for connecting the computer to an imaging device 6 or another electronic device.

The storing medium driving device 508 reads a program or data recorded in a removable storing medium (not illustrated), and writes data or the like stored in the auxiliary storage 503 to the removable storing medium. As the removable storing medium, a flash memory that is installed with a connector of a USB standard can be used, for example. As the removable storing medium, an optical disk, such as a Compact Disc (CD), a Digital Versatile Disc (DVD), or a Blu-ray Disc (Blu-ray is a registered trademark), can be used.

The communication device 509 is a device that communicably connects the computer 5 to another computer or the like via a communication network 7 such as the Internet.

The computer 5 causes the CPU 501 to read a program including the encoding above from the auxiliary storage 503 and to encode moving image data in cooperation with the DSP 504, the main memory 502, the auxiliary storage 503, and the like. At this time, the CPU 501 causes the DSP 504 to perform an operation in encoding. The DSP 504 performs orthogonal transformation, quantization, entropy encoding, or the like on a picture to be encoded so as to generate a bit stream, or performs inverse quantization, inverse orthogonal transformation, or the like on a quantized picture so as to generate a reference picture used in motion estimation. The DSP 504 also performs processing as illustrated in FIGS. 24 to FIG. 28 so as to determine whether the SAO processing on a chrominance signal is suppressed when the reference picture is generated.

Data of a moving image encoded by the computer 5 is stored, for example, in the auxiliary storage 503, and is decoded (reproduced) by the computer 5 as needed. The encoded moving image data can be provided (distributed) to another computer via the communication network 7, for example, by using the communication device 509. The encoded moving image data can be recorded in an optical disk or the like, for example, by using the storing medium driving device 508, and can be stored or distributed.

The computer 5 used as the encoder 1 does not always need to have the configuration illustrated in FIG. 29, and may have a configuration in which the CPU 501 encodes a moving image. The computer 5 is not limited to a general-purpose computer that implements a plurality of functions by executing various programs, and may be an information processing device specialized for encoding or decoding of a moving image.

The inhibiting mode setting process in the SAO processing on a chrominance signal described in the embodiment above does not always need to be applied to the intra-refresh, but can be applied to another moving image encoding in which a reference area is restricted when a motion vector is calculated. As an example, the inhibiting mode setting process can be applied to moving image encoding performed by setting a Region Of Interest (ROI) or the like.

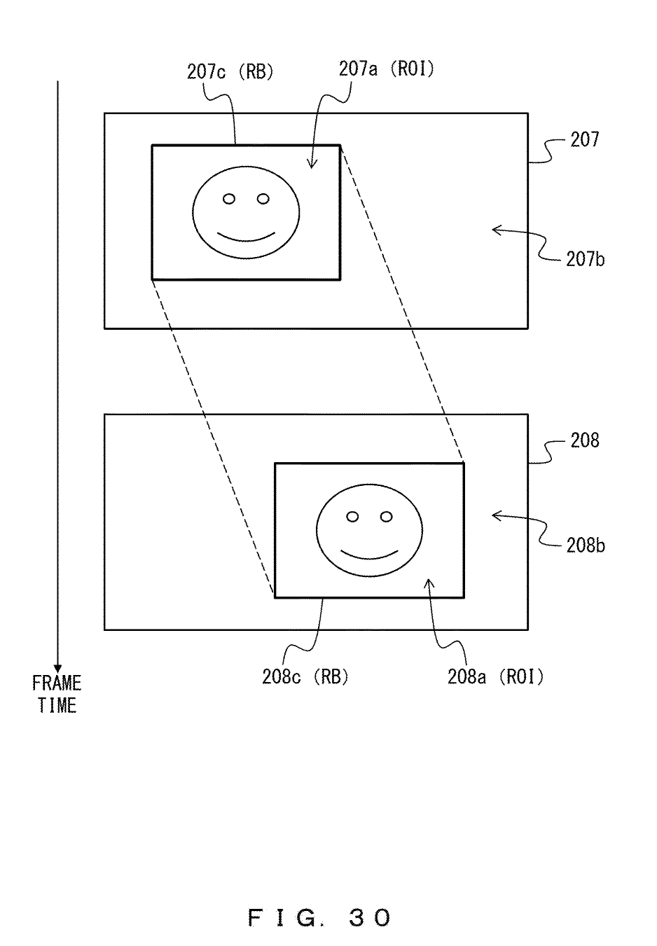

FIG. 30 is a diagram explaining moving image encoding performed by setting a ROI.

In encoding performed by setting a ROI (hereinafter referred to “ROI encoding”), the ROI can be set partially in a picture. The ROI is an area that a viewer is interested in or hopes to emphasize, such as a person's face illustrated in FIG. 30. In ROI encoding, the number of bits to be allocated to areas 207b and 208b outside ROIs 207a and 208a is reduced, and the reduced bits are used to encode the ROIs such that image quality of the ROIs 207a and 208a is improved.

In ROI encoding, a reference destination of a motion vector included in the ROI 208a of a current picture 208 is limited to the ROI 207a of a past picture 207, as illustrated in FIG. 30, for example. Consequently, a moving image decoder can recover the ROI 208a of the current picture 208 by storing only the ROI 207a of the past picture 207 so as to reduce an amount of memory. In ROI encoding, transcoding can be performed by changing the size of an image so as to include only the ROI, without performing motion estimation that has a large processing amount.

As described above, when a reference destination of a motion vector of a block included in the ROI 208a of the current picture 208 is limited to the ROI 207a of the past picture 207 in ROI encoding, an outer periphery 207c of the ROI is a reference restriction boundary RB (a vector restriction boundary VB). Therefore, when the SAO processing is performed in an encoding loop, reference restriction as illustrated in FIG. 11 or the like is generated in an encoded block including a right-hand side of the ROI. By setting the above chrominance filter inhibiting mode for the encoded block including the right-hand side of the ROI, a referable area of a chrominance signal can be suppressed from being reduced when a motion vector is calculated.

When a ROI is rectangular, a vector restriction boundary VB is rectangular. Accordingly, as an example, in an encoded block including an upper side of the ROI, reference restriction whereby an area on a lower side of the upper side of the ROI (the vector restriction boundary VB) is a referable area and an area on an upper side of the upper side of the ROI is a reference inhibition area is generated. Stated another way, in ROI encoding, there are an encoded block for which a reference restriction type is Type 0, an encoded block for which reference restriction type is Type 1, an encoded block for which reference restriction type is Type 2, and an encoded block for which reference restriction type is Type 3 in one picture. Further, the reference restriction type of an encoded block including a corner, for example, a right-upper corner, of a ROI is Type 0 and Type 3.

Even when one picture includes encoded blocks of difference reference restriction types, an optimum chrominance filter inhibiting mode can be set for each of the reference restriction types in the above chrominance filter inhibiting mode setting process. As an example, in the reference restriction type setting process illustrated in FIG. 26, Type 0 is set for an encoded block including only a right-hand side of the ROI, and Type 3 is set for an encoded block including only an upper side of the ROI. Type 0 and Type 3 are set for an encoded block including the right-hand side and the upper side of the ROI. In the chrominance filter inhibiting mode setting process illustrated in FIG. 28, a chrominance filter inhibiting mode is set that corresponds to the type of the reference restriction type and the number of the reference restriction types that have been set for an encoded block.

Stated another way, a chrominance filter inhibiting mode that corresponds to reference restriction type 0 is set for an encoded block including only the right-hand side of the ROI, and a chrominance filter inhibiting mode associated to reference restriction type 3 is set for an encoded block including only the upper side of the ROI. Two chrominance filter inhibiting modes, the chrominance filter inhibiting mode that corresponds to reference restriction type 0 and the chrominance filter inhibiting mode that corresponds to reference restriction type 3, are set for an encoded block including the right-hand side and the upper side of the ROI.

Accordingly, by setting a chrominance filter inhibiting mode for respective encoded blocks including an outer periphery of the ROI in the processing described in the embodiment, a referable area of a chrominance signal can be suppressed from being reduced when a motion vector is calculated. Consequently, deterioration in image quality in the outer periphery within the ROI can be suppressed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A moving image encoder comprising:
a motion estimator configured to divide a picture including a luminance signal and a chrominance signal into a plurality of encoded blocks, to reference an encoded picture so as to calculate a motion vector of the luminance signal in each of the plurality of encoded blocks, the encoded picture being provided with a first area in which reference by a subsequent picture is allowed and a second area in which the reference is inhibited, the encoded picture having a reference area of the motion vector of the luminance signal restricted, and to calculate the motion vector of the chrominance signal on the basis of the calculated motion vector of the luminance signal;
a filter configured to individually perform filtering on the luminance signal and the chrominance signal in a decoded image of a picture to be encoded;
a boundary position calculator configured to calculate a reference restriction type that indicates a combination of a reference restriction boundary position indicating a boundary position between the first area and the second area before the filtering on a current picture to be encoded, and a position relationship between the first area and the second area;
a suppression determiner configured to determine whether the filtering on the chrominance signal is suppressed on the basis of the reference restriction type, and to generate chrominance filter suppression information;
an inhibiting mode specifier configured to calculate the encoded block in which the filtering on the chrominance signal is suppressed on the basis of the reference restriction boundary position before the filtering, and to specify a chrominance filter inhibiting mode indicating a chrominance filter mode in which a pixel included in the second area may be referenced;
a reference restriction specifier configured to specify a reference restriction position of the luminance signal after the filtering on the basis of the reference restriction boundary position before the filtering and the chrominance filter suppression information; and
an encoder configured to encode the picture to be encoded by using the motion vector of the luminance signal that has been derived by referencing the first area on the basis of the chrominance filter mode selected from among the chrominance filter modes other than the chrominance filter inhibiting mode, and the reference restriction position of the luminance signal after the filtering.

2. The moving image encoder according to claim 1, wherein the boundary position calculator calculates the reference restriction boundary position on the basis of the boundary position between a vector restriction area indicating an area in which reference restriction is performed when the encoded picture is encoded and an area in which the reference restriction is not performed, and an influence range of pixel rewriting performed after the calculating of the motion vector of the luminance signal and before the filtering.

3. The moving image encoder according to claim 1, wherein
the boundary position calculator calculates the reference restriction type categorized according to a direction in which the first area exists, the direction being a leftward direction, a rightward direction, an upper direction, or a lower direction of the reference restriction boundary position in the encoded block, or any combination thereof.

4. The moving image encoder according to claim 1, wherein
the suppression determiner determines whether the chrominance filter is suppressed on the basis of a combination of the reference restriction type and image format information defining a sampling method of the chrominance signal in the picture.

5. The moving image encoder according to claim 1, wherein
the inhibiting mode specifier specifies the encoded block including at least the reference restriction boundary before the filtering, or the encoded block adjacent to the reference restriction boundary to be the encoded block in which the chrominance filter is suppressed.

6. The moving image encoder according to claim 1, wherein
the suppression determiner specifies the encoded block including the reference restriction boundary before the filtering, or all of the encoded blocks in a specific area in the picture including a block adjacent to the reference restriction boundary to be the block in which the chrominance filter is suppressed.

7. The moving image encoder according to claim 1, wherein
when there are a plurality of chrominance filter types, and when a specific type of the chrominance filter type includes the chrominance filter mode in which a pixel included in the second area may be referenced, the inhibiting mode specifier inhibits the specific type of the chrominance filter type.

8. The moving image encoder according to claim 1, wherein
the inhibiting mode specifier inhibits the chrominance filter type other than the chrominance filter type in which the filtering is not performed.

9. The moving image encoder according to claim 1, further comprising:
a boundary position storage configured to store the reference restriction boundary position before the filtering in the current picture to be encoded, the reference restriction boundary position being calculated by the boundary position calculator, during a time period after the current picture to be encoded is encoded and before the current picture to be encoded is no longer referenced in encoding of the subsequent picture.

10. A moving image encoder comprising:
a memory configured to store a picture to be encoded including a luminance signal and a chrominance signal, an encoded picture, and a decoded image of the picture to be encoded; and
a processor configured to:
divide the picture including the luminance signal and the chrominance signal into a plurality of encoded blocks, reference the encoded picture so as to calculate a motion vector of the luminance signal in each of the plurality of encoded blocks, the encoded picture being provided with a first area in which reference by a subsequent picture is allowed and a second area in which the reference is inhibited, the encoded picture having a reference area of the motion vector of the luminance signal restricted, and calculate the motion vector of the chrominance signal on the basis of the calculated motion vector of the luminance signal;
individually perform filtering on the luminance signal and the chrominance signal in the decoded image of the picture to be encoded;
calculate a reference restriction type that indicates a combination of a reference restriction boundary position indicating a boundary position between the first area and the second area before the filtering on a current picture to be encoded, and a position relationship between the first area and the second area;
determine whether the filtering on the chrominance signal is suppressed on the basis of the reference restriction type, and generate chrominance filter suppression information;
calculate the encoded block in which the filtering on the chrominance signal is suppressed on the basis of the reference restriction boundary position before the filtering, and specify a chrominance filter inhibiting mode indicating a chrominance filter mode in which a pixel included in the second area may be referenced;
specify a reference restriction position of the luminance signal after the filtering on the basis of the reference restriction boundary position before the filtering and the chrominance filter suppression information; and
encode the picture to be encoded by using the motion vector of the luminance signal that has been derived by referencing the first area on the basis of the chrominance filter mode selected from among the chrominance filter modes other than the chrominance filter inhibiting mode, and the reference restriction position of the luminance signal after the filtering.

11. A moving image encoding method for causing a processor to perform a process comprising:
dividing a picture to be encoded including a luminance signal and a chrominance signal into a plurality of encoded blocks; and
referencing an encoded picture so as to calculate a motion vector of the luminance signal in each of the plurality of encoded blocks, the encoded picture being provided with a first area in which reference by a subsequent picture is allowed and a second area in which the reference is inhibited, the encoded picture having a reference area of the motion vector of the luminance signal restricted, and calculating the motion vector of the chrominance signal on the basis of the calculated motion vector of the luminance signal,
the process further comprising:
calculating a reference restriction type that indicates a combination of a reference restriction boundary position indicating a boundary position between the first area and the second area before filtering on a current picture to be encoded, and a position relationship between the first area and the second area;
determining whether the filtering on the chrominance signal is suppressed on the basis of the reference restriction type, and generating chrominance filter suppression information;
calculating the encoded block in which the filtering on the chrominance signal is suppressed on the basis of the reference restriction boundary position before the filtering, and specifying a chrominance filter inhibiting mode indicating a chrominance filter mode in which a pixel included in the second area may be referenced;
specifying the reference restriction boundary position of the luminance signal after the filtering on the basis of the reference restriction boundary position before the filtering and the chrominance filter suppression information;
individually performing the filtering on the luminance signal and the chrominance signal in a decoded image of the picture on the basis of the chrominance filter inhibiting mode and the reference restriction boundary position of the luminance signal; and
encoding the picture to be encoded by using the motion vector of the luminance signal that has been derived by referencing the first area on the basis of the chrominance filter mode selected from among the chrominance filter modes other than the chrominance filter inhibiting mode, and a reference restriction position of the luminance signal after the filtering.

12. A non-transitory computer-readable recording medium having stored therein a program for causing a computer to execute a process for encoding a moving image, the process comprising:
dividing a picture to be encoded including a luminance signal and a chrominance signal into a plurality of encoded blocks; and
referencing an encoded picture so as to calculate a motion vector of the luminance signal in each of the plurality of encoded blocks, the encoded picture being provided with a first area in which reference by a subsequent picture is allowed and a second area in which the reference is inhibited, the encoded picture having a reference area of the motion vector of the luminance signal restricted, and calculating the motion vector of the chrominance signal on the basis of the calculated motion vector of the luminance signal,
the process further comprising:
calculating a reference restriction type that indicates a combination of a reference restriction boundary position indicating a boundary position between the first area and the second area before filtering on a current picture to be encoded, and a position relationship between the first area and the second area;
determining whether the filtering on the chrominance signal is suppressed on the basis of the reference restriction type, and generating chrominance filter suppression information;
calculating the encoded block in which the filtering on the chrominance signal is suppressed on the basis of the reference restriction boundary position before the filtering, and specifying a chrominance filter inhibiting mode indicating a chrominance filter mode in which a pixel included in the second area may be referenced;
specifying the reference restriction boundary position of the luminance signal after the filtering on the basis of the reference restriction boundary position before the filtering and the chrominance filter suppression information;
individually performing the filtering on the luminance signal and the chrominance signal in a decoded image of the picture on the basis of the chrominance filter inhibiting mode and the reference restriction boundary position of the luminance signal; and
encoding the picture to be encoded by using the motion vector of the luminance signal that has been derived by referencing the first area on the basis of the chrominance filter mode selected from among the chrominance filter modes other than the chrominance filter inhibiting mode, and a reference restriction position of the luminance signal after the filtering.
